(19) United States
(12) Patent Application Publication
(10) Pub. No.: US 2019/0169877 A1
(43) Pub. Date: Jun. 6, 2019

(54) LOCK ASSEMBLY

(71) Applicants: Oren Fishkin, North York (CA); Tal Shlomovich, Toronto (CA)

(72) Inventors: Oren Fishkin, North York (CA); Tal Shlomovich, Toronto (CA); Ennio Pecile, Toronto (CA)

(73) Assignees: Oren Fishkin, North York (CA); Tal Shlomovich, Toronto (CA)

(21) Appl. No.: 15/830,337

(22) Filed: Dec. 4, 2017

(51) Int. Cl. E05B 37/00; E05B 63/08; E05B 37/08; E05B 37/02; E05B 63/00

(52) U.S. Cl. CPC E05B 37/0031; E05B 63/08; E05B 63/0004; E05B 37/02; E05B 37/08

(57) ABSTRACT

An apparatus includes a lock assembly configured to be selectively coupled to a selectively-movable lock member of a mortise-cylinder housing of a mortise cylinder. The lock assembly includes visible symbols configured to be selectively movable. This is done in such a way that the visible symbols, in use, urge the selectively-movable lock member of the mortise-cylinder housing of the mortise cylinder to move from a locked state to an unlocked state.

### TECHNICAL FIELD

This document relates to the technical field of (and is not limited to) a lock assembly, and/or to a lock assembly including visibly movable symbols, and/or to a lock assembly configured to be selectively coupled to a selectively-movable lock member of a mortise-cylinder housing of a mortise cylinder (in which the lock assembly includes visibly movable symbols), and/or a method therefor.

### BACKGROUND

Commercial or industrial door systems are installed with a latch housing. The latch housing is installed in an edge section of the door system. A mortise cylinder is installed to (and is removable from) the latch housing. A key is made to operate the internal mechanisms mounted in (installed in) the interior of the mortise cylinder. It will be appreciated that there are mechanisms that take (receive) the mortise cylinder for utilization with residential locks (for example, mortise cassettes, and/or for application with residential situations). Moreover, the mortise cylinder is typically utilized for commercial situations or applications (but not limited to only commercial applications). It will be appreciated that the latch housing may include a latch mechanism and/or any equivalent thereof, such as a bolt-action mechanism, etc.

### SUMMARY

It will be appreciated that there exists a need to mitigate (at least in part) at least one problem associated with the existing locks (also called the existing technology). After much study of the known systems and methods with experimentation, an understanding (at least in part) of the problem and its solution has been identified (at least in part) and is articulated (at least in part) as follows:

For the case where a replacement key is required for an existing mortise cylinder (which has an existing key), the existing mortise cylinder is simply removed from the mortise housing, and is then replaced with a replacement mortise cylinder that has a replacement key that is matched with the replacement mortise cylinder. The existing key and the existing mortise cylinder are discarded (or may be redeployed for or reinstalled in (to) another door system, if so desired).

Some users find it very inconvenient to utilize keys for a mortise cylinder for the case where the existing key is lost or misplaced, which then requires the undesired or inconvenient replacement of the existing mortise cylinder. It will be appreciated that locks do not necessarily need to be changed, and that the locks may be rekeyed (if desired).

What may be needed is a way to improve the convenience for users of mortise cylinders.

To mitigate, at least in part, at least one problem associated with the existing technology, there is provided (in accordance with a major aspect) an apparatus. The apparatus includes and is not limited to (comprises) a lock assembly configured to be selectively coupled to a selectively-movable lock member of a mortise-cylinder housing of a mortise cylinder. The lock assembly includes visible symbols configured to be selectively movable. This is done in such a way that the visible symbols, in use, urge the selectively-movable lock member of the mortise-cylinder housing of the mortise cylinder to move from a locked state to an unlocked state.

In accordance with an embodiment, the lock assembly is to be installed in a building having a stationary wall. A stationary door frame is configured to be mounted to the stationary wall of the building. A movable door is configured to be mounted to the stationary door frame. The movable door is also configured to be selectively movable between a door-closed condition and a door-open condition. A latch housing is configured to be mounted in an edge section of the movable door in such a way that the latch housing, in use, faces the stationary door frame once the latch housing is mounted in the edge section of the movable door. The movable door is moved from an open-door condition to a closed-door condition. The latch housing supports a latch device (and any equivalent thereof, such as a bolt-action device, etc.). The latch device is configured to selectively latch (or selectively bolt) with the stationary door frame once the latch housing, in use, is mounted in the edge section of the movable door, and once the latch housing, in use, faces the stationary door frame in such a way that the latch device, in use, securely prevents movement of the movable door away from the stationary door frame, and the movable door, in use, remains in the door-closed condition with the latch device placed in a latched condition. The latch device is configured to selectively unlatch (or selectively unbolt) from the stationary door frame in such a way that the latch device, in use, permits free movement of the movable door away from the stationary door frame, and the movable door is movable to the door-open condition with the latch device placed in an unlatched condition. The mortise-cylinder housing is configured to be selectively receivable by, and supportable by, and selectively removable from, the latch housing. The mortise-cylinder housing supports the selectively-movable lock member. The selectively-movable lock member is configured to interface with the latch device of the latch housing once the mortise-cylinder housing, in use, is received by, and supported by, the latch housing.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 to FIG. 40 depict views in accordance with aspects of a first embodiment of a lock assembly; and

FIG. 41 to FIG. 65 depict views in accordance with aspects of a second embodiment of a lock assembly; and

more specifically:

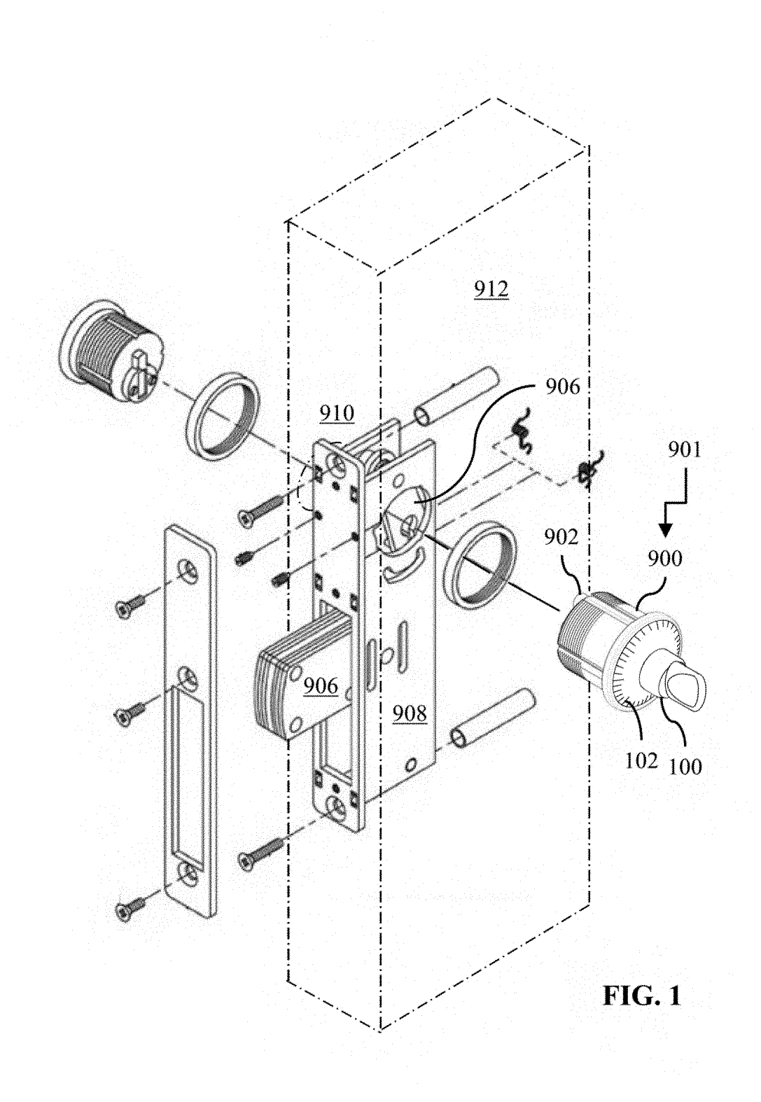

FIG. 1 depicts a perspective view of a first embodiment of a lock assembly; and

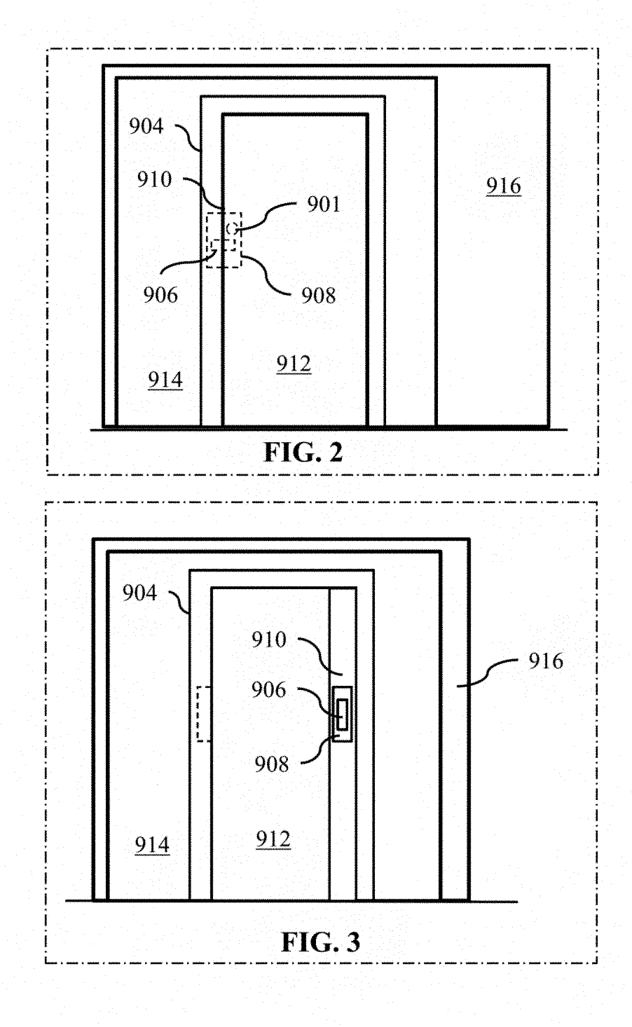

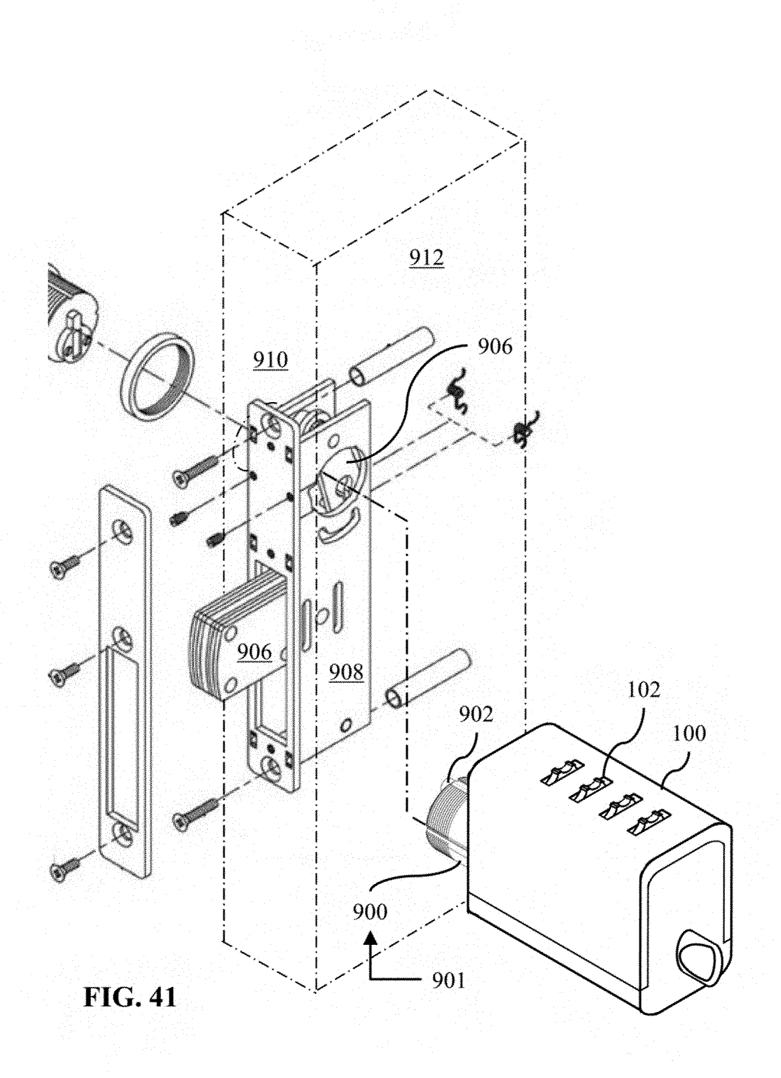

FIG. 2 and FIG. 3 depict front views of embodiments of the lock assembly of FIG. 1 and of FIG. 41 (FIG. 2 and FIG. 3 are both applicable to the first and second embodiments); and

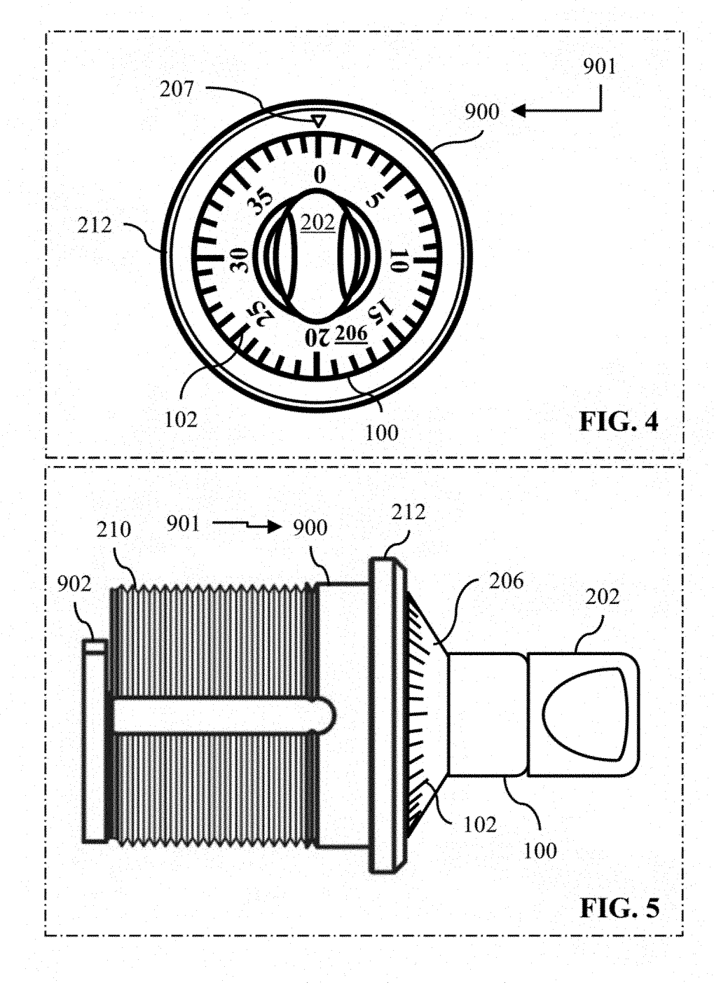

FIG. 4 and FIG. 5 depict a front view (FIG. 4) and a side view (FIG. 5) of embodiments of the lock assembly of FIG. 1; and

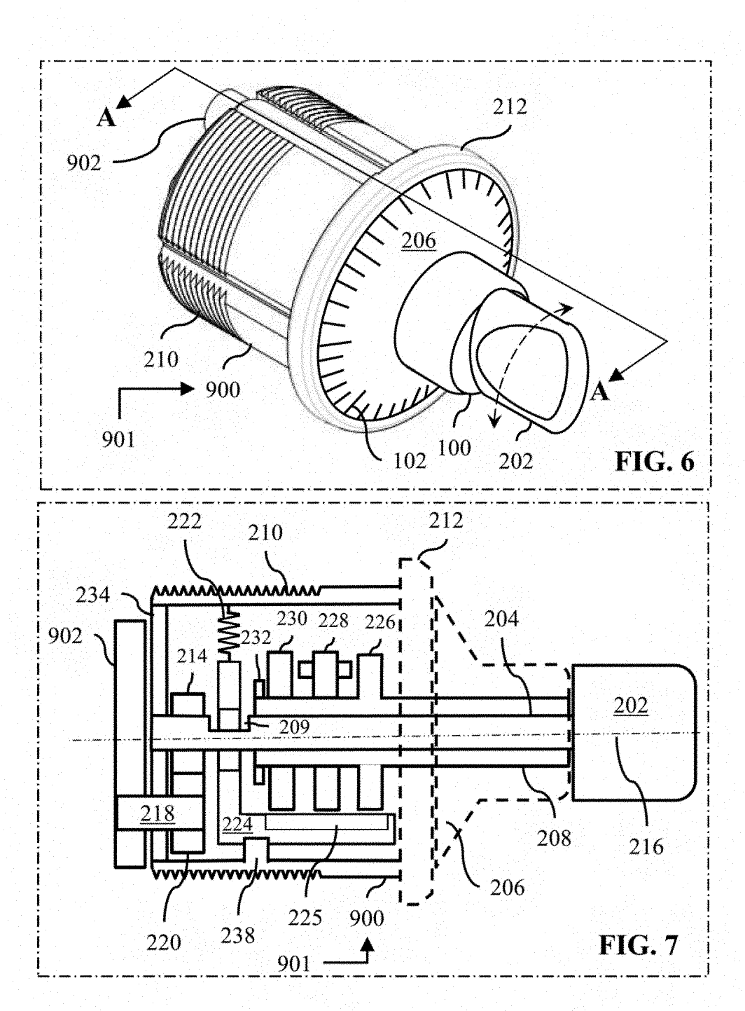

FIG. 6 and FIG. 7 depict a perspective view (FIG. 6) and a cross-sectional side view (FIG. 7) of embodiments of the lock assembly of FIG. 1; and

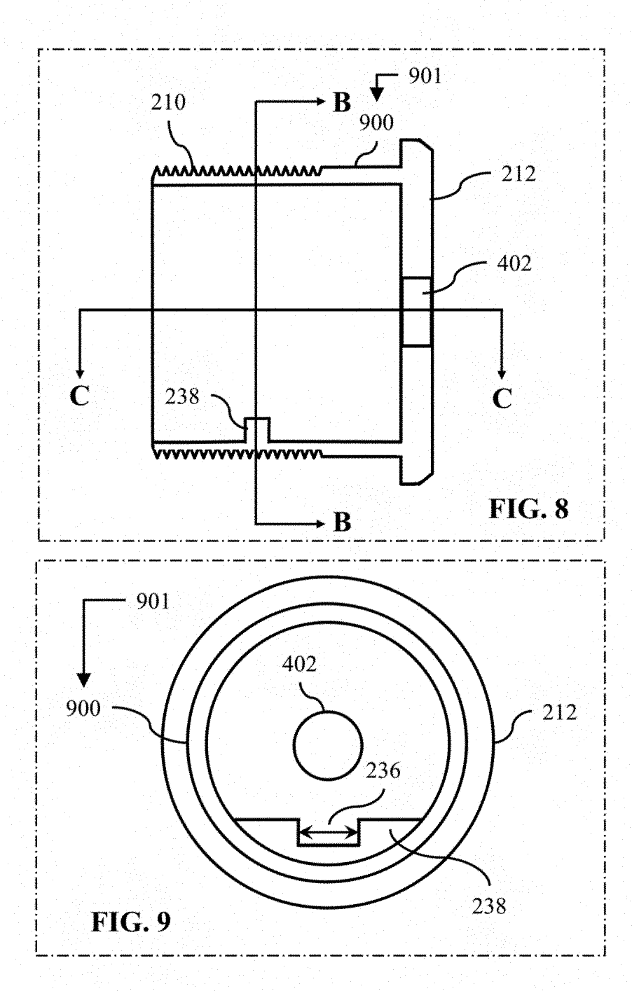

FIG. 8 and FIG. 9 depict a cross-sectional side view (FIG. 8) and a cross-sectional front view (FIG. 9) of embodiments of the lock assembly of FIG. 6; and

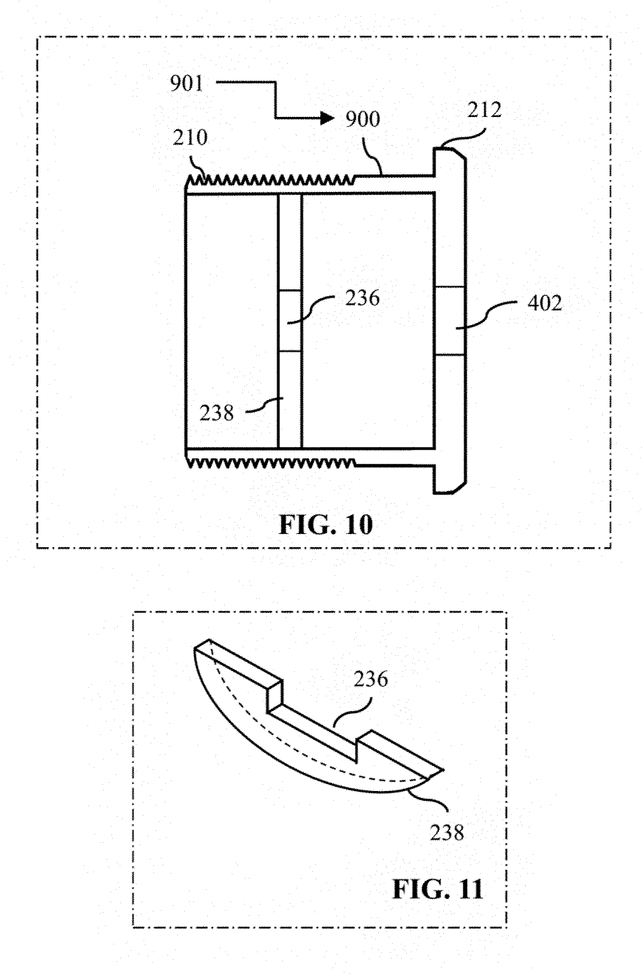

FIG. 10 and FIG. 11 depict a cross-sectional bottom view (FIG. 10) and a perspective view (FIG. 11) of embodiments of the lock assembly of FIG. 6; and

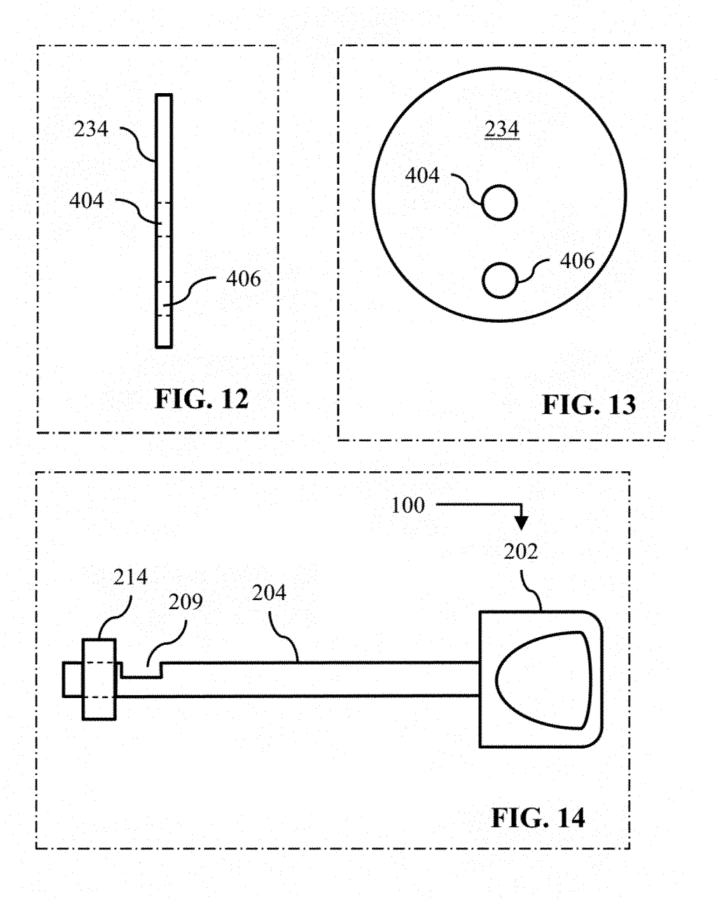

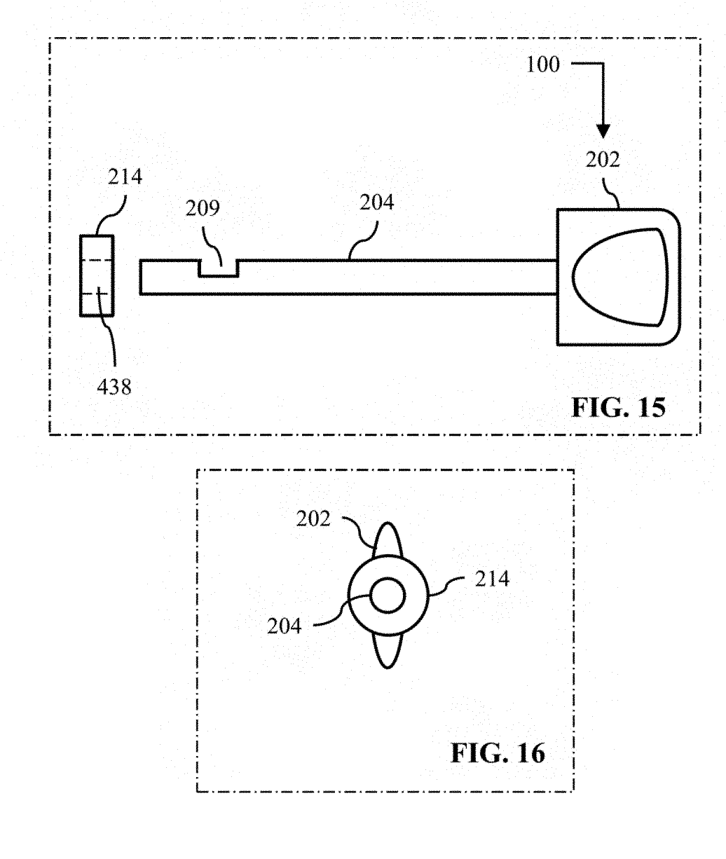

FIG. 12, FIG. 13 and FIG. 14 depict a side view (FIG. 12), a front view (FIG. 13) and a side view (FIG. 14) of embodiments of the lock assembly of FIG. 7; and

FIG. 15 and FIG. 16 depict a side view (FIG. 15) and a front view (FIG. 16) of embodiments of the lock assembly of FIG. 6; and

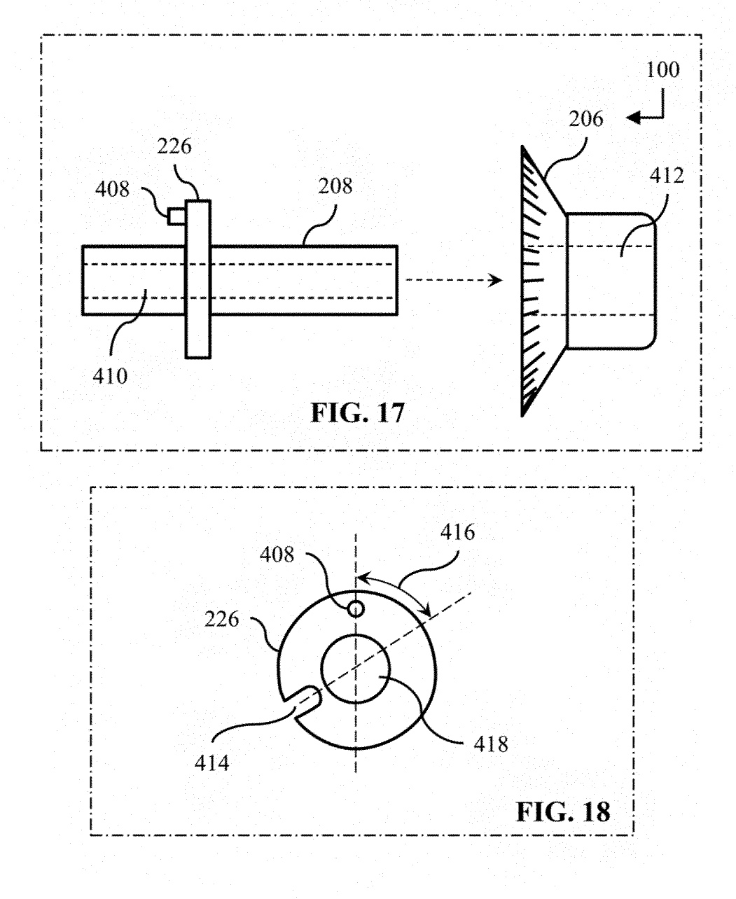

FIG. 17 and FIG. 18 depict a side view (FIG. 17) and a front view (FIG. 18) of embodiments of the lock assembly of FIG. 7; and

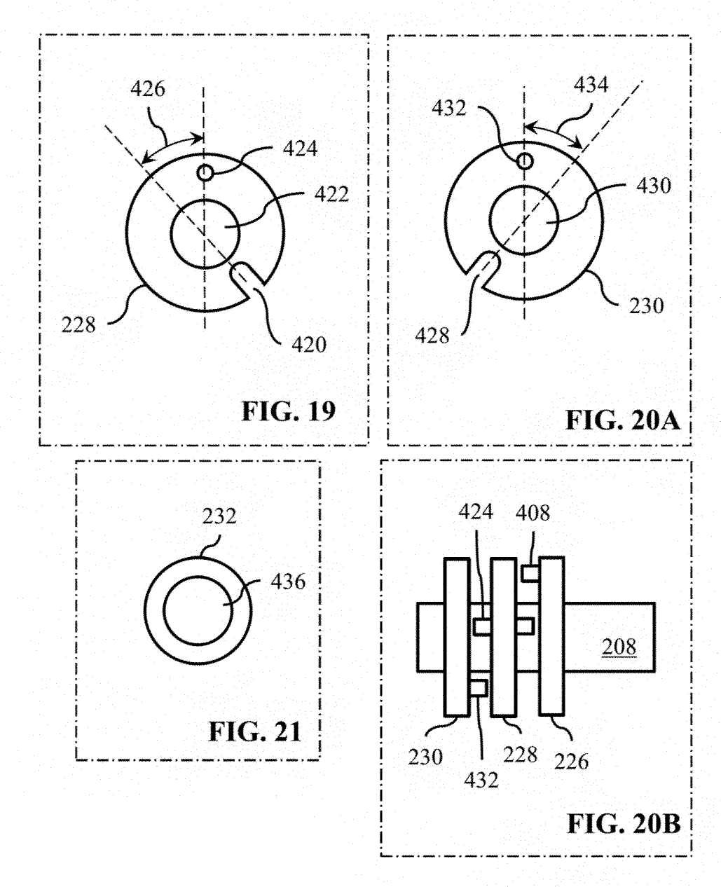

FIG. 19, FIG. 20A, FIG. 20B and FIG. 21 depict front views (FIG. 19, FIG. 20A and FIG. 21) and a side view (FIG. 20B) of embodiments of the lock assembly of FIG. 7; and

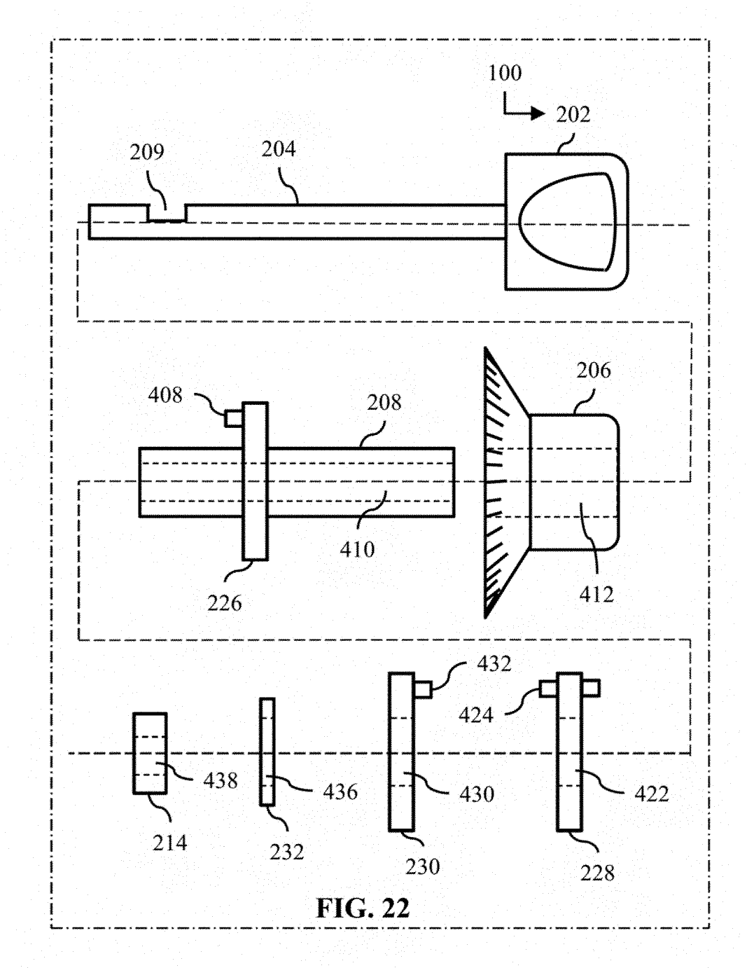

FIG. 22 depicts a side view of an embodiment of the lock assembly of FIG. 6; and

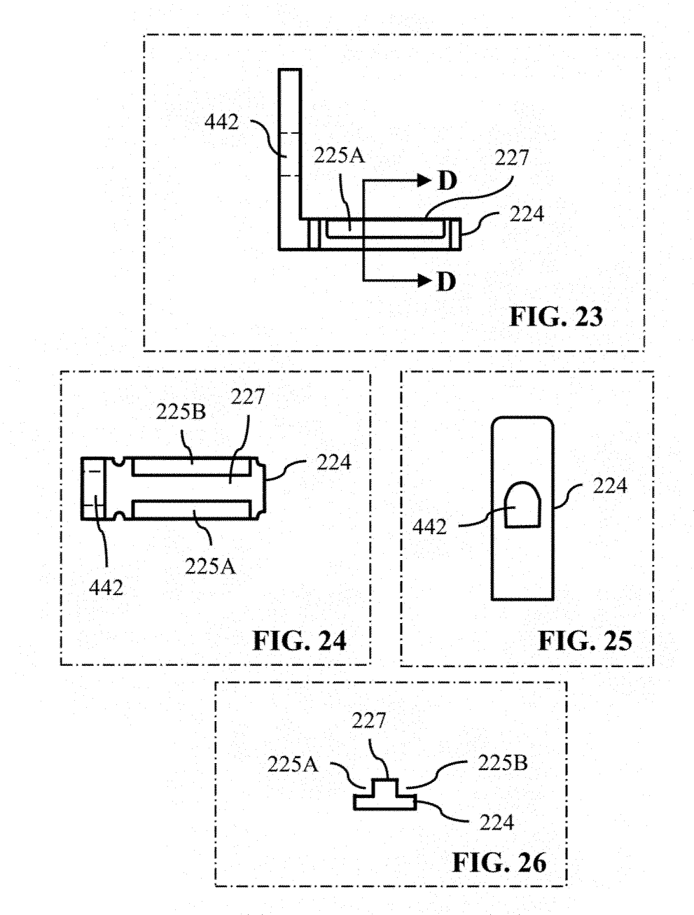

FIG. 23, FIG. 24, FIG. 25 and FIG. 26 depict a side view (FIG. 23), a top view (FIG. 24), an end view (FIG. 25) and a cross-sectional view (FIG. 26) of embodiments of the lock assembly of FIG. 7; and

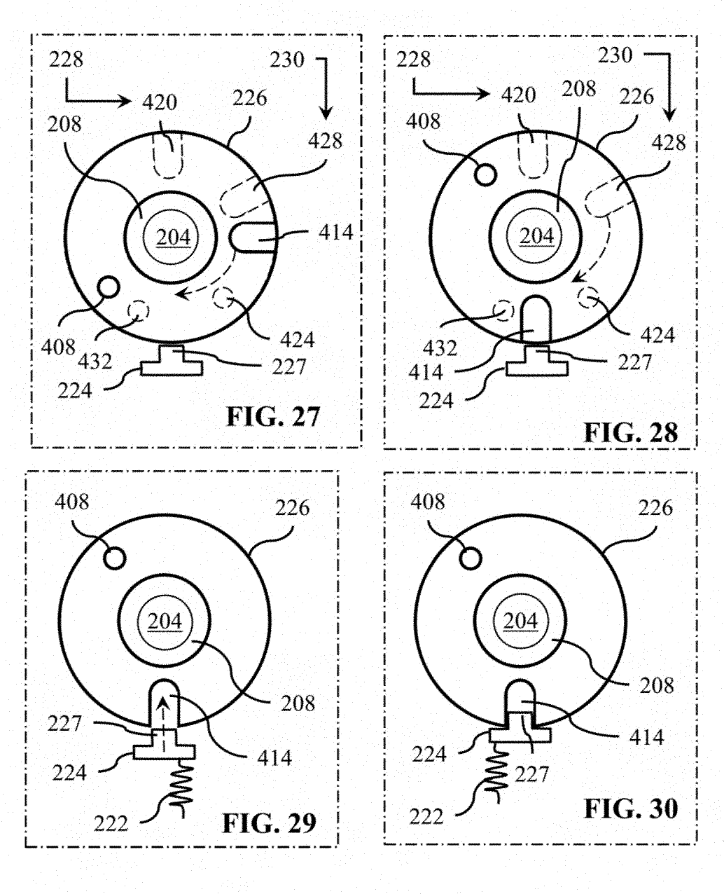

FIG. 27 to FIG. 30 depict side views of embodiments of the lock assembly of FIG. 7; and

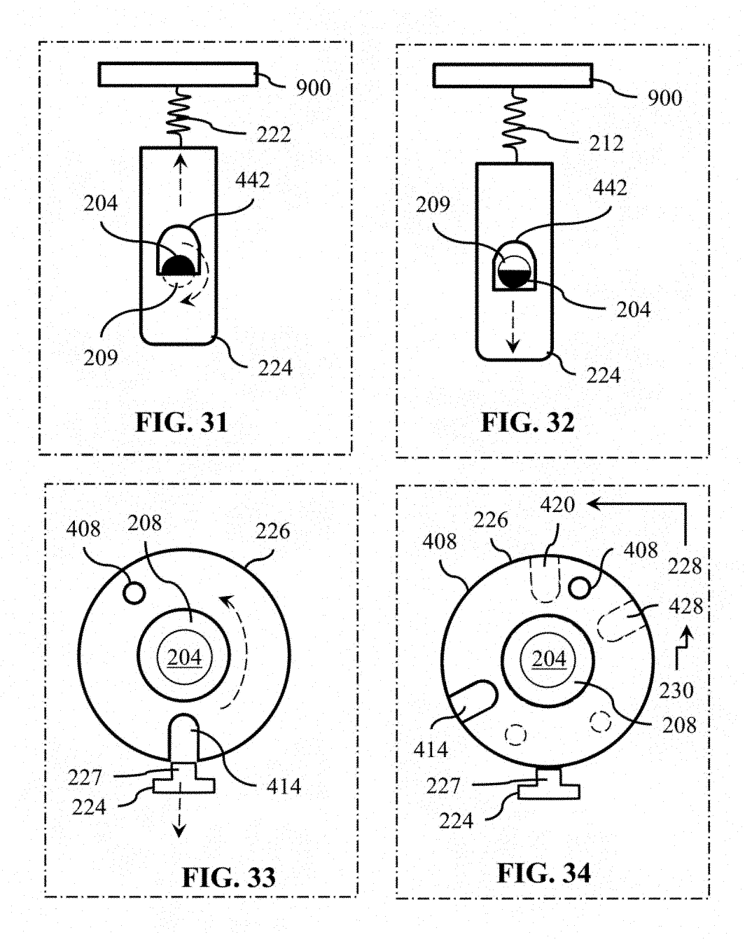

FIG. 31 to FIG. 34 depict side views of embodiments of the lock assembly of FIG. 7; and

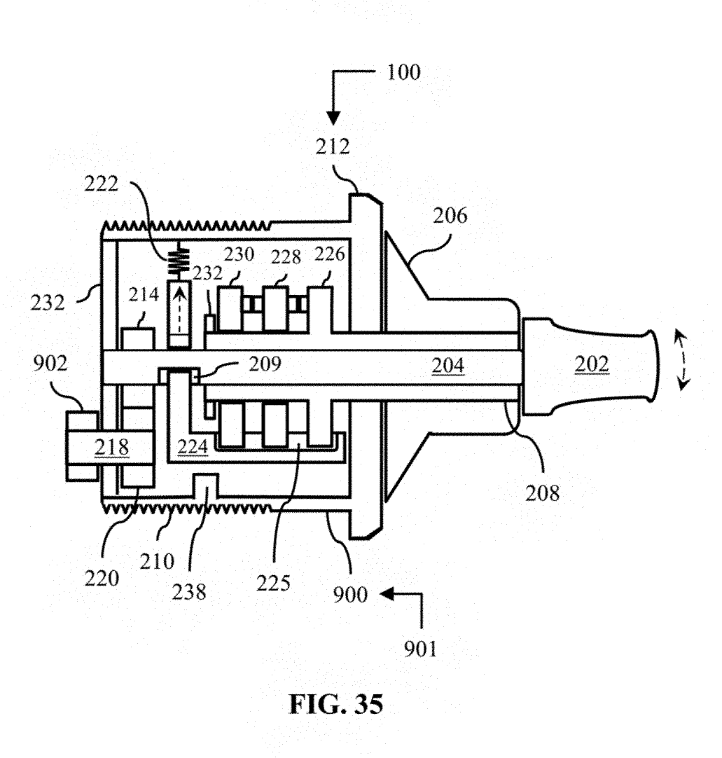

FIG. 35 depicts a cross-sectional view of an embodiment of the lock assembly of FIG. 6; and

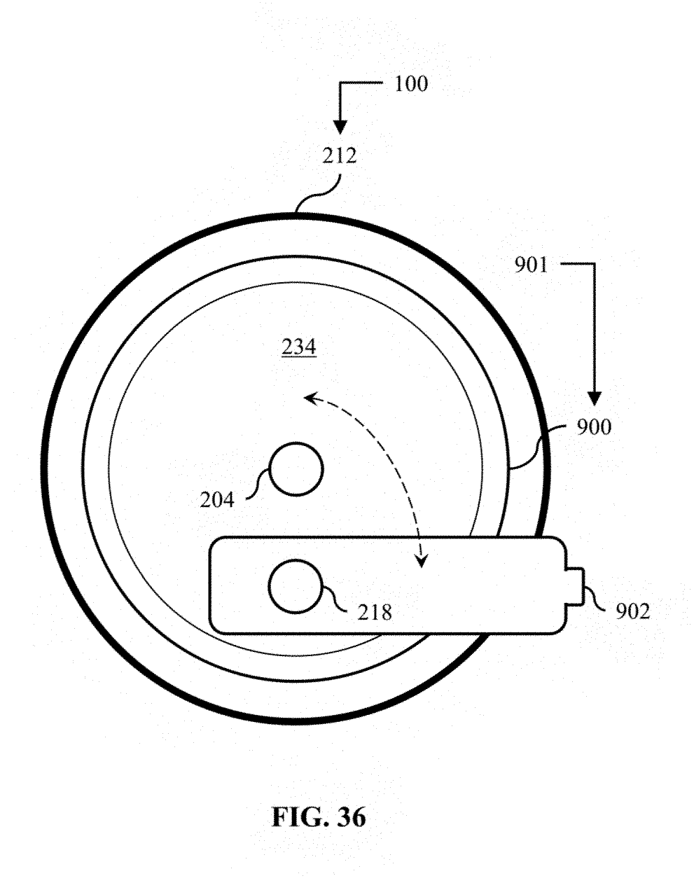

FIG. 36 depicts an end view of an embodiment of the lock assembly of FIG. 35; and

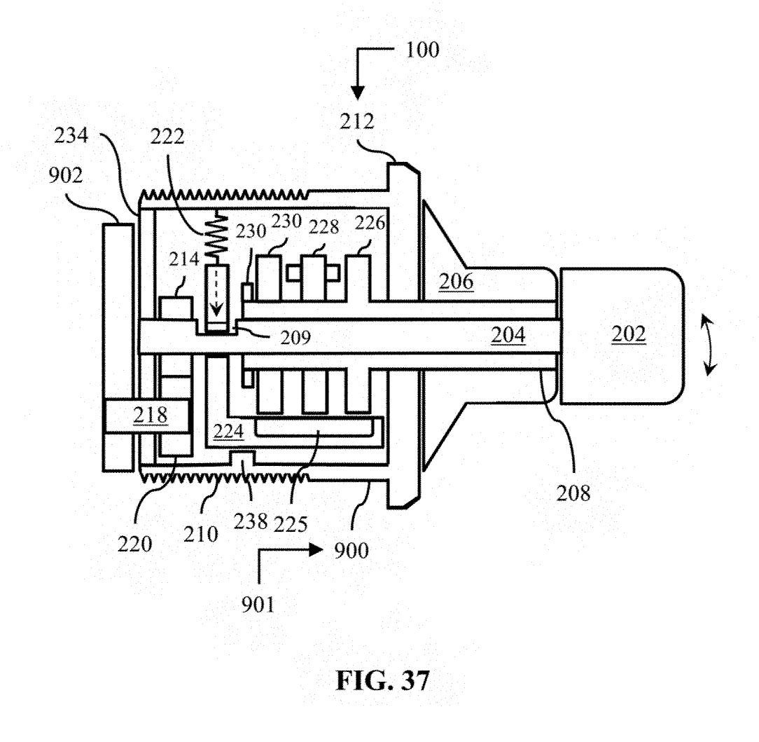

FIG. 37 depicts a cross-sectional view of an embodiment of the lock assembly of FIG. 6; and

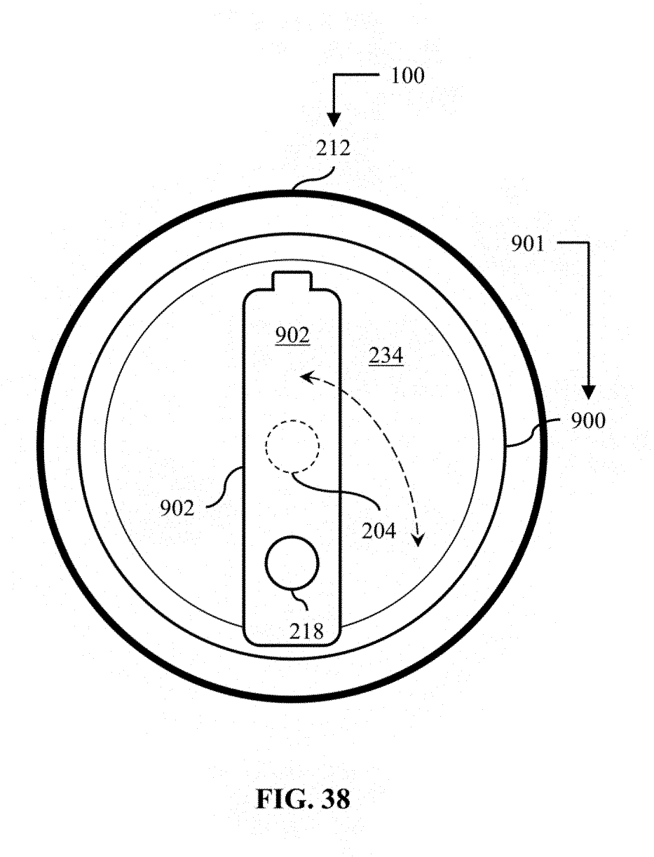

FIG. 38 depicts an end view of an embodiment of the lock assembly of FIG. 37; and

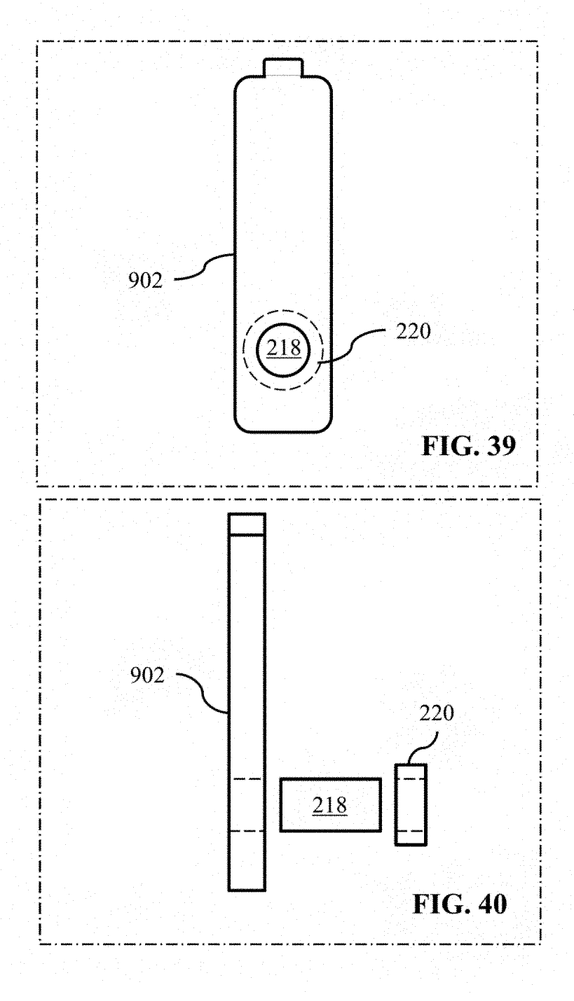

FIG. 39 and FIG. 40 depict an end view (FIG. 39) and a side view (FIG. 40) of embodiments of the lock assembly of FIG. 7; and

FIG. 41 depicts a perspective view of a second embodiment of a lock assembly; and

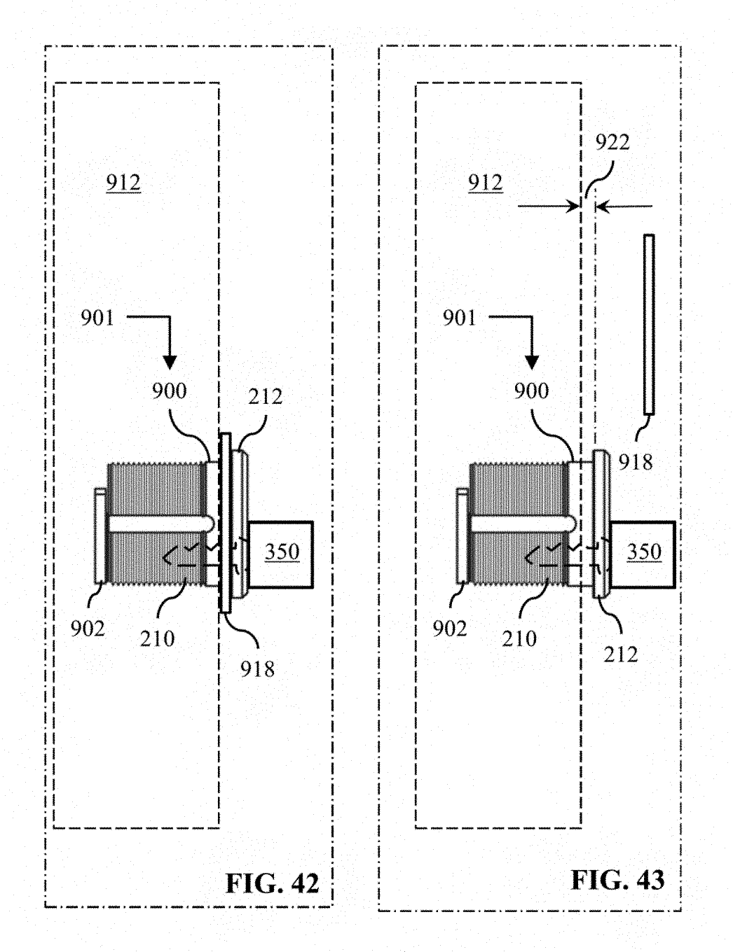

FIG. 42 and FIG. 43 depict side views of embodiments of the lock assembly of FIG. 41; and

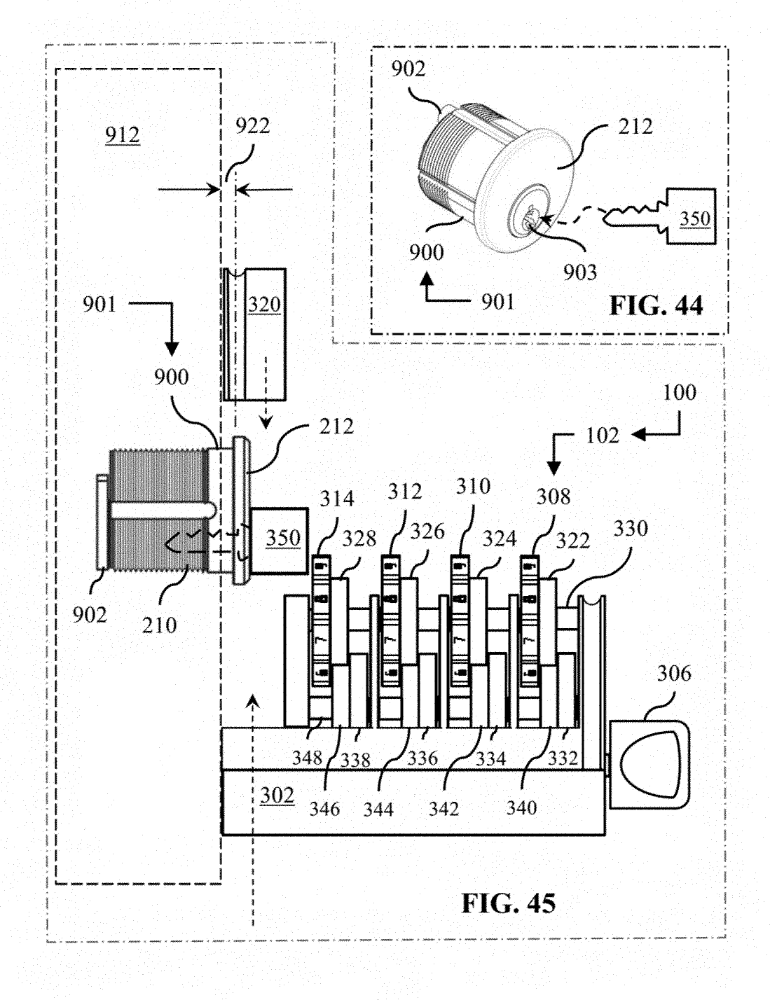

FIG. 44 and FIG. 45 depict a perspective view (FIG. 44) and a side view (FIG. 45) of embodiments of the lock assembly of FIG. 41; and

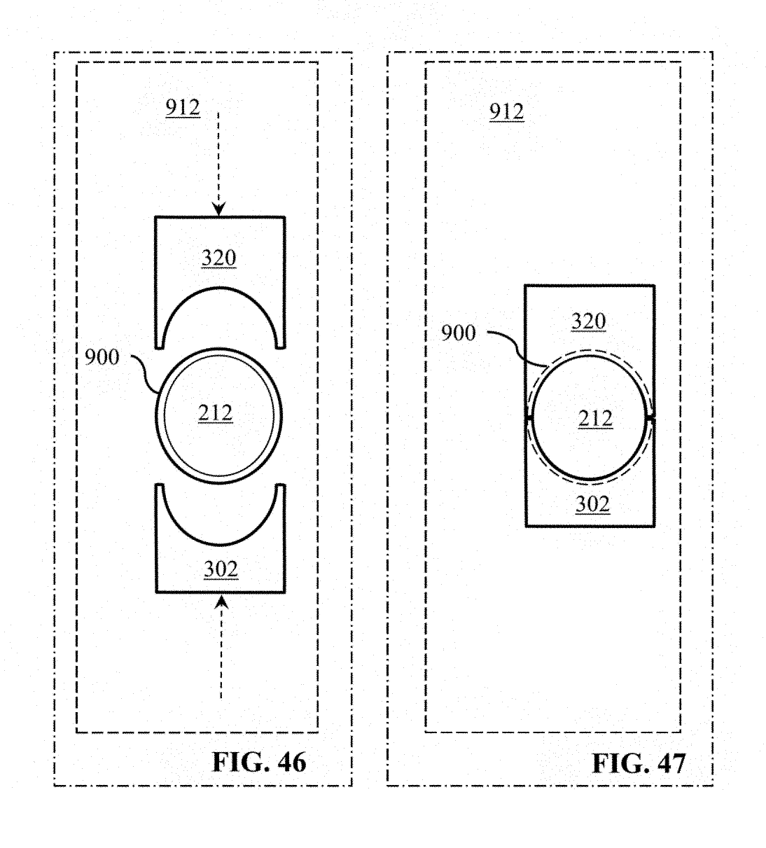

FIG. 46 and FIG. 47 depict front views of embodiments of the lock assembly of FIG. 45; and

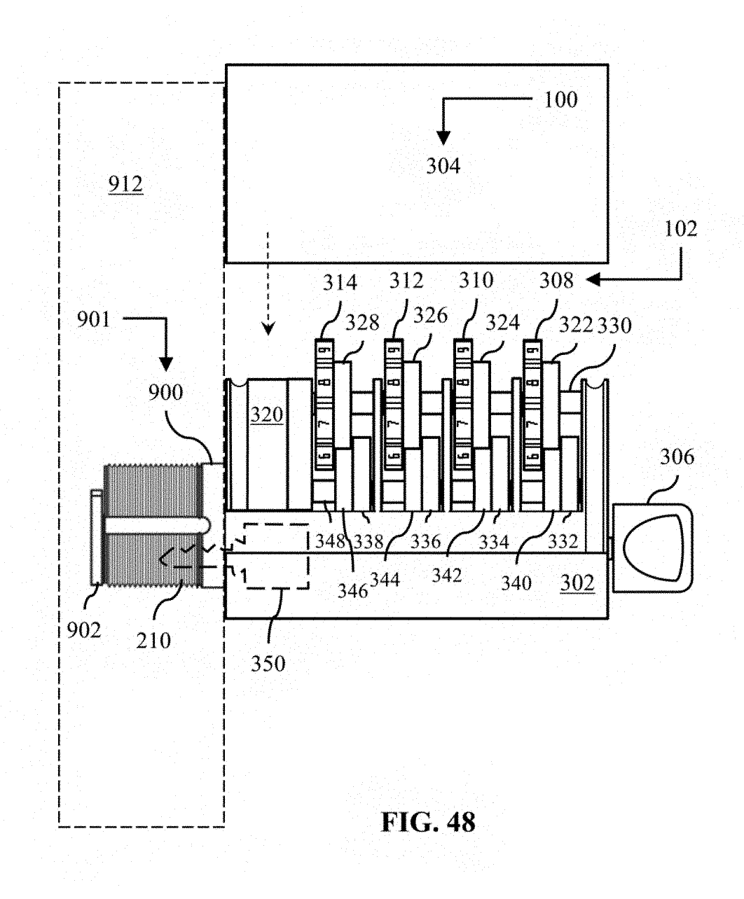

FIG. 48 depicts a side view of an embodiment the lock assembly of FIG. 41; and

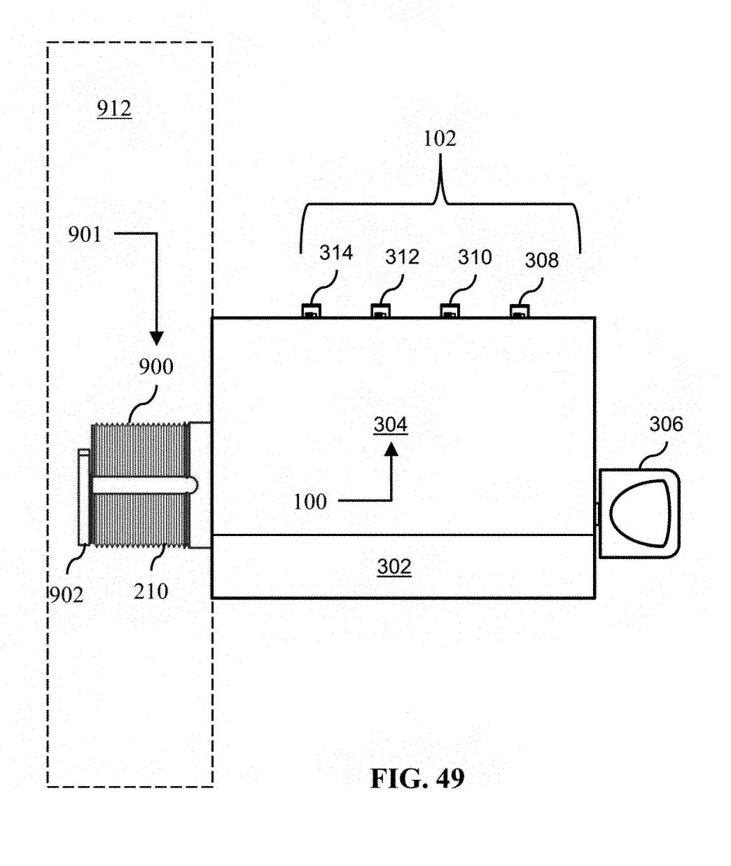

FIG. 49 depicts a side view of an embodiment the lock assembly of FIG. 41; and

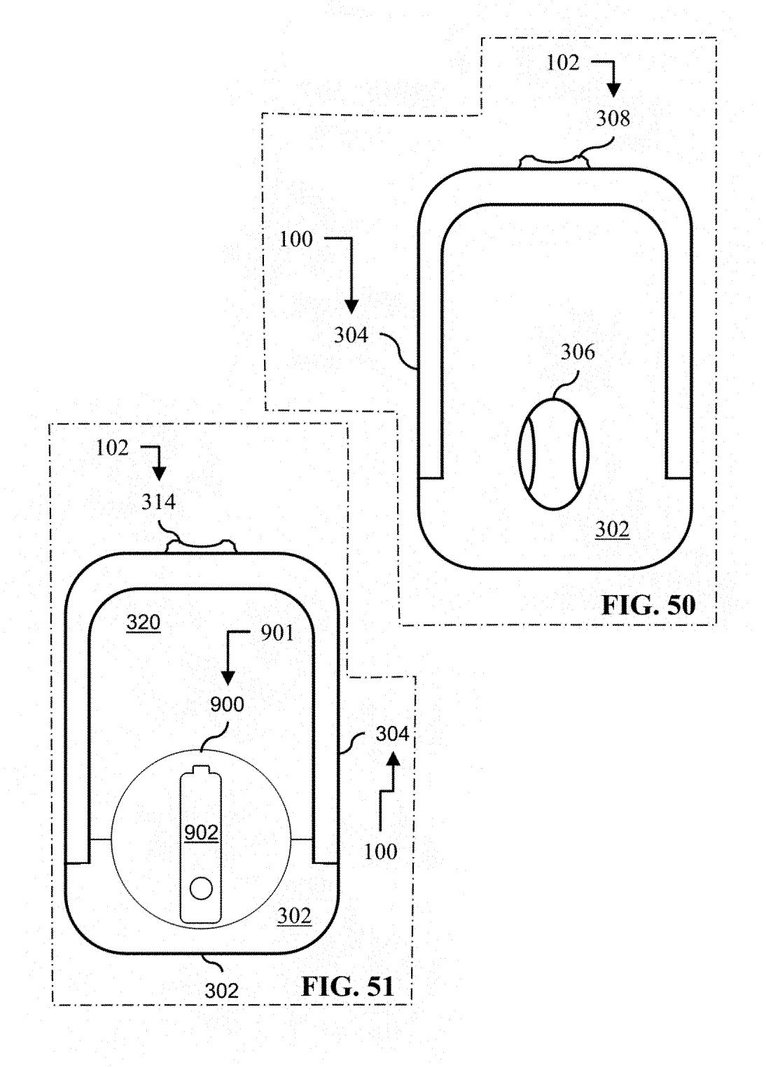

FIG. 50 and FIG. 51 depict a front view (FIG. 50) and a rear view (FIG. 51) of embodiments of the lock assembly of FIG. 41; and

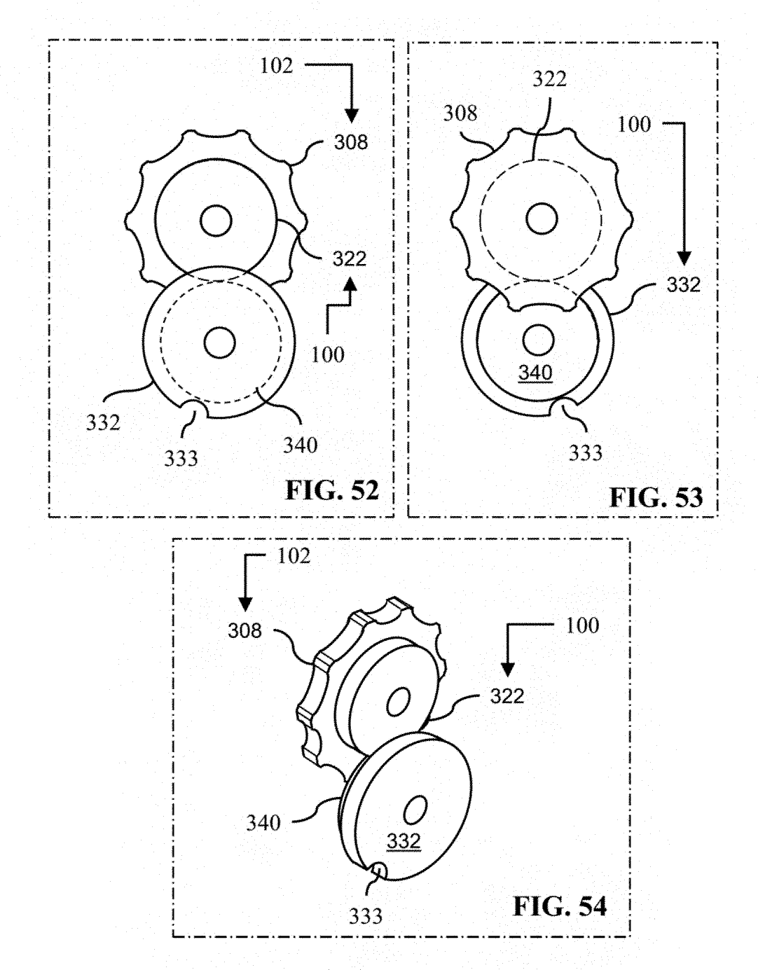

FIG. 52, FIG. 53 and FIG. 54 depict a front view (FIG. 52), a rear view (FIG. 53) and a perspective view (FIG. 54) of embodiments of the lock assembly of FIG. 41; and

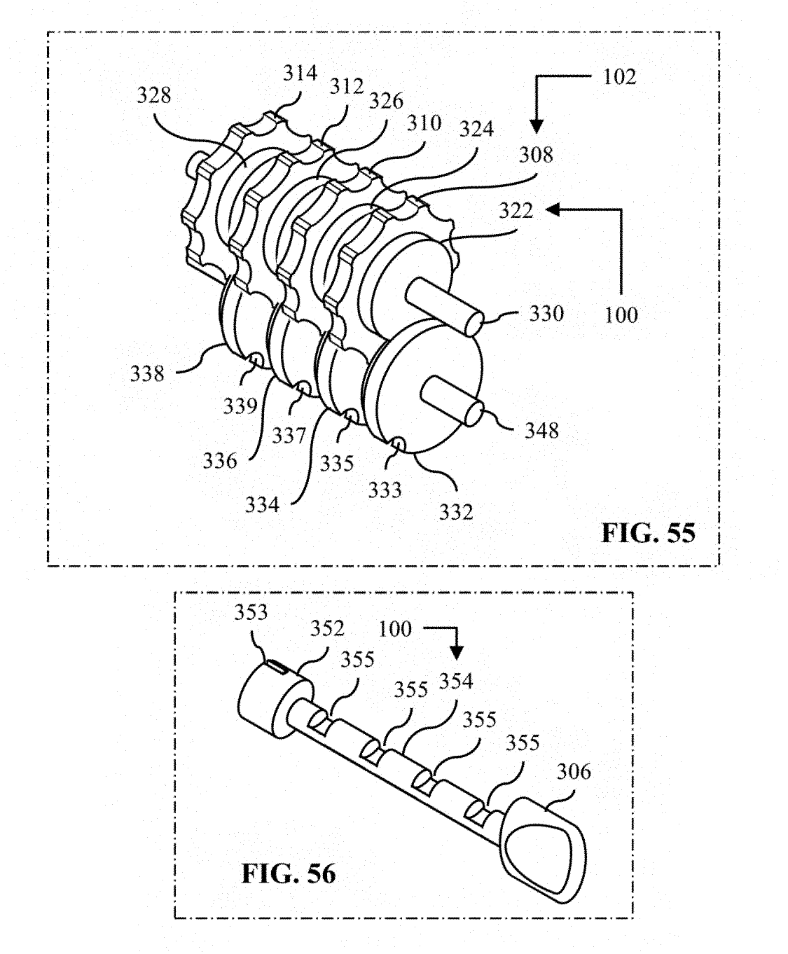

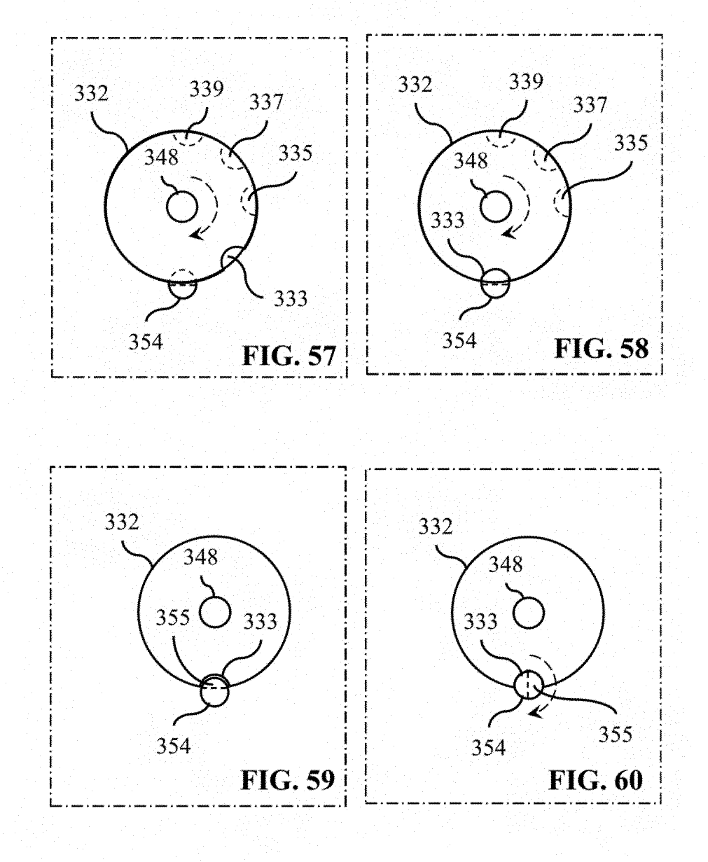

FIG. 55 and FIG. 56 depict perspective views of embodiments of the lock assembly of FIG. 41; and

FIG. 57 to FIG. 60 depict end views of embodiments of the lock assembly of FIG. 41;

and

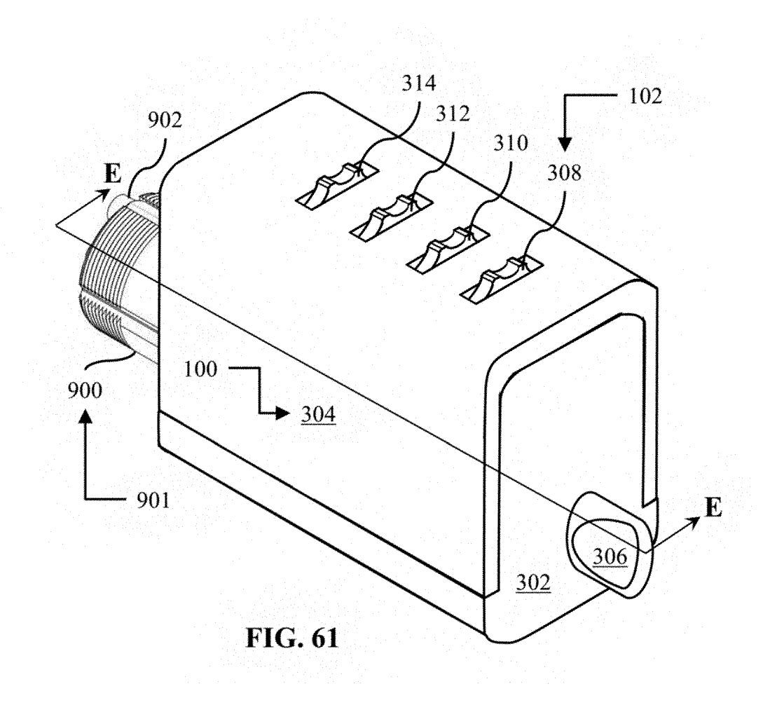

FIG. 61 depicts a perspective view of an embodiment of the lock assembly of FIG. 41; and

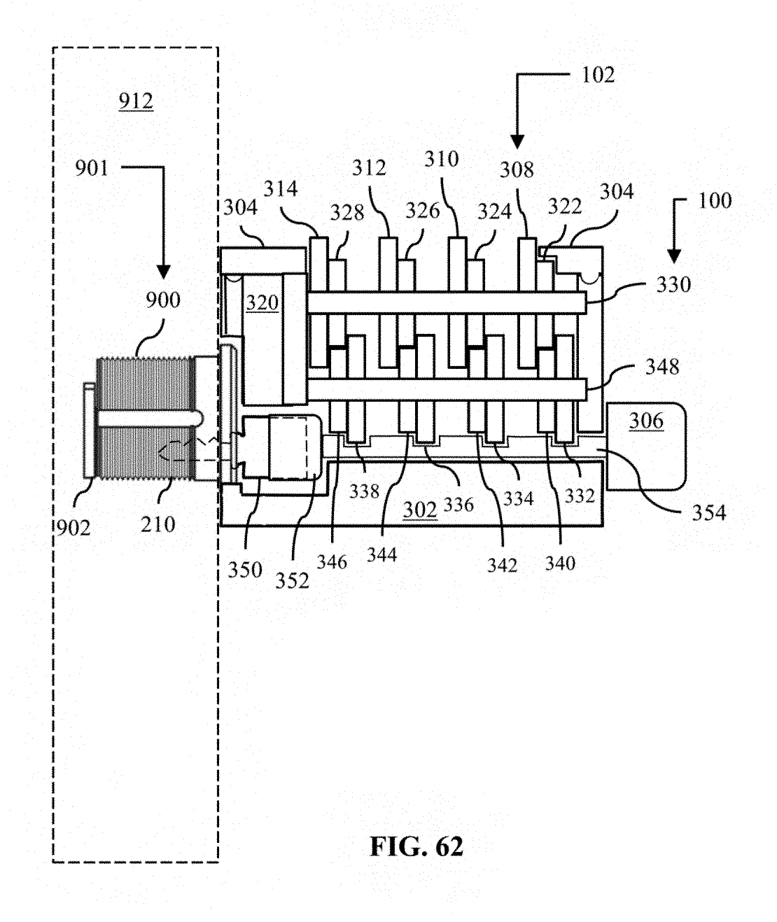

FIG. 62 depicts a cross-sectional view of an embodiment of the lock assembly of FIG. 61; and

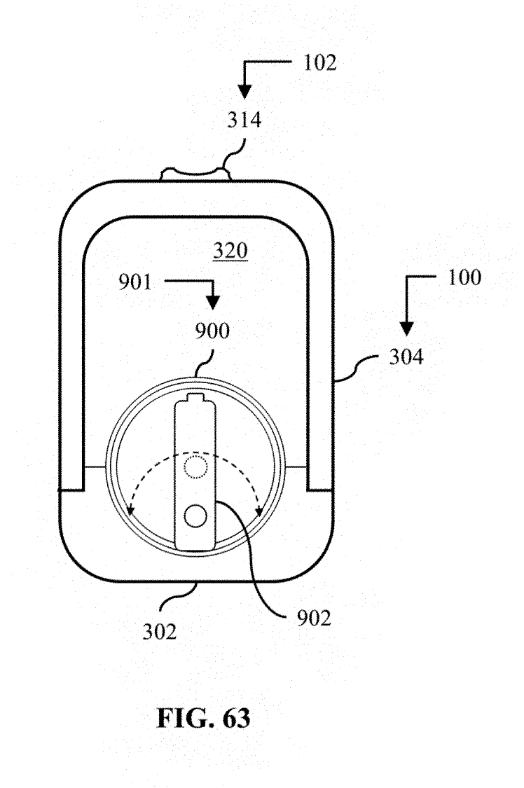

FIG. 63 depicts a rear view of an embodiment of the lock assembly of FIG. 62; and

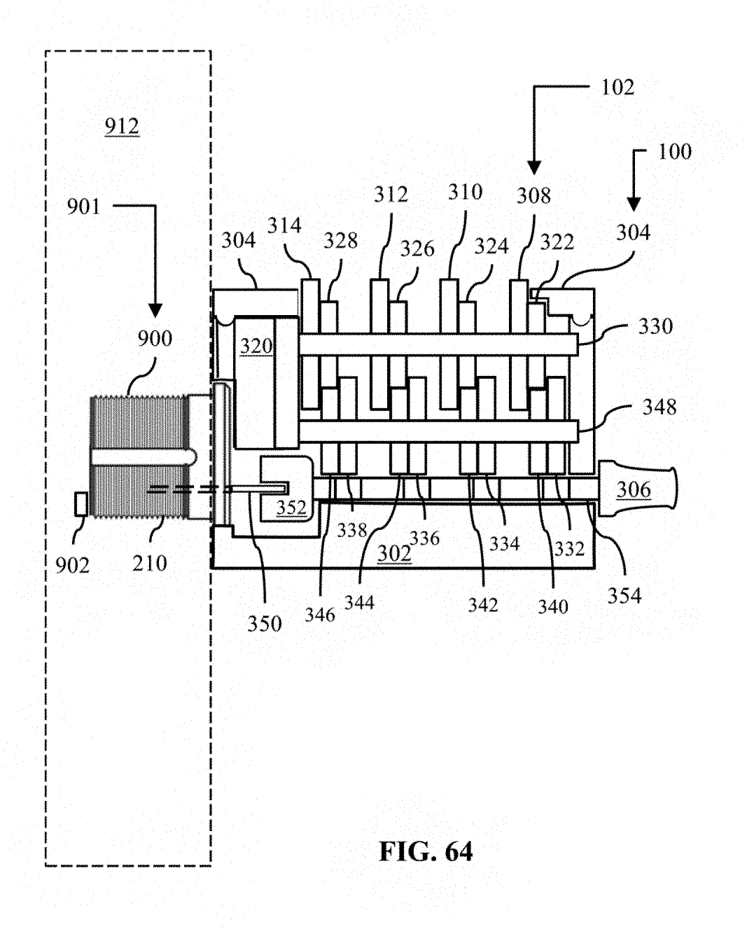

FIG. 64 depicts a cross-sectional view of an embodiment of the lock assembly of FIG. 61; and

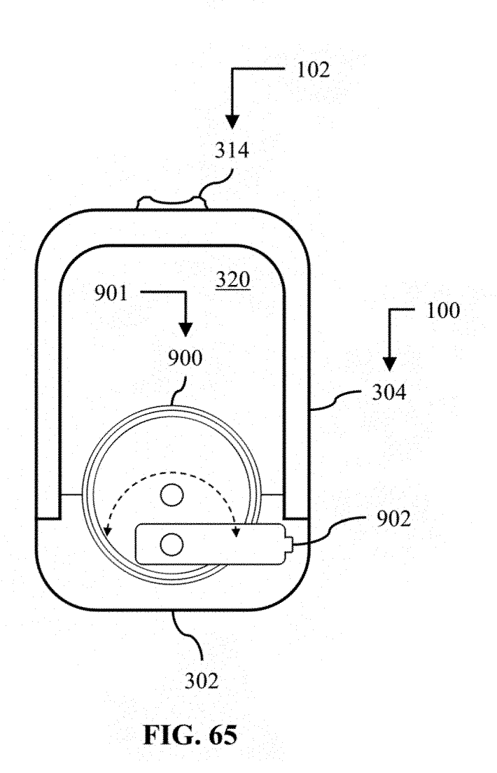

FIG. 65 depicts a rear view of an embodiment of the lock assembly of FIG. 64.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 lock assembly
102 visible symbols
202 turn handle
204 turn shaft
206 dial
207 reference marker
208 dial shaft
209 shaft groove
210 threads
212 front plate
214 turn-shaft gear
216 rotation axis
218 gear shaft
220 gear
222 slide spring
224 slide device
225A first channel
225B second channel
225 slide channel
226 first tumbler disk
227 crown
228 second tumbler disk
230 third tumbler disk
232 tumbler retainer
234 back plate
236 slide channel
238 slide body
302 main housing
304 removable housing
306 turn handle
308 first numbered dial
310 second numbered dial
312 third numbered dial
314 fourth numbered dial
320 holder
322 first gear
324 second gear
326 third gear
328 fourth gear
330 dial shaft
332 first tumbler disc
333 first notch
334 second tumbler disc
335 second notch
336 third tumbler disc
337 third notch
338 fourth tumbler disc
339 fourth notch
340 first tumbler disc gear
342 second tumbler disc gear
344 third tumbler disc gear
346 fourth tumbler disc gear
348 tumbler disc shaft
350 key
352 turnkey adapter
353 key notch
354 turn shaft
355 mating notch
402 first hole
404 second hole
406 third hole
408 first extension member
410 fourth hole
412 fifth hole
414 first lock hole
416 first angle
418 first central hole
420 second lock hole
422 second central hole
424 second extension member
426 second angle
428 third lock hole
430 third central hole
432 third extension member
434 third angle
436 retainer hole
438 gear hole
442 slide hole
900 mortise-cylinder housing
901 mortise cylinder
902 selectively-movable lock member
903 keyway
904 stationary door frame
906 latch device
908 latch housing
910 edge section
912 movable door
914 stationary wall
916 building
918 flange assembly
922 gap

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

FIG. 1 to FIG. 40 depict views in accordance with aspects of a first embodiment of a lock assembly 100. Specifically, FIG. 1 depicts a perspective view, FIG. 2 and FIG. 3 depict front views, FIG. 4 depicts a front view, FIG. 5 depicts a side view, FIG. 6 depicts a perspective view, FIG. 7 depicts a cross-sectional side view, FIG. 8 depicts a cross-sectional side view, FIG. 9 depicts a cross-sectional front view, FIG. 10 depicts a cross-sectional bottom view, FIG. 11 depicts a perspective view, FIG. 12 depicts a side view, FIG. 13 depicts a front view, FIG. 14 depicts a side view, FIG. 15 depicts a side view, FIG. 16 depicts a front view, FIG. 17 depicts a side view, FIG. 18 depicts a front view, FIG. 19, FIG. 20A and FIG. 21 depict front views, FIG. 20B depicts a side view, FIG. 22 depicts a side view, FIG. 23 depicts a side view, FIG. 24 depicts a top view, FIG. 25 depicts an end view, FIG. 27 to FIG. 30 depict side views, FIG. 31 to FIG. 34 depict side views, FIG. 35 depicts a cross-sectional view, FIG. 36 depicts an end view, FIG. 37 depicts a cross-sectional view, FIG. 38 depicts an end view, FIG. 39 depicts an end view, and FIG. 40 depicts a side view.

FIG. 41 to FIG. 65 depict views in accordance with aspects of a second embodiment of a lock assembly 100. More specifically, FIG. 41 depicts a perspective view, FIG. 42 and FIG. 43 depict side views, FIG. 44 depicts a perspective view, FIG. 45 depicts a side view, FIG. 46 and FIG. 47 depict front views, FIG. 48 depicts a side view, FIG. 49 depicts a side view, FIG. 50 depicts a front view, FIG. 51 depicts a rear view, FIG. 52 depicts a front view, FIG. 53 depicts a rear view, FIG. 54 depicts a perspective view, FIG. 55 and FIG. 56 depict perspective views, FIG. 57 to FIG. 60 depict end views, FIG. 61 depicts a perspective view, FIG. 62 depicts a cross-sectional view, FIG. 63 depicts a rear view, FIG. 64 depicts a cross-sectional view, and FIG. 65 depicts a rear view.

In accordance with the first and second embodiments as depicted in FIG. 1, FIG. 2, FIG. 3 and FIG. 41, there is provided an apparatus, in which the apparatus includes (and is not limited to) a synergistic combination of elements. The apparatus is for (is configured for) utilization with a selectively-movable lock member 902 (also called a lock member) of (mounted to) a mortise-cylinder housing 900 of a mortise cylinder 901. The apparatus includes (and is not limited to) a lock assembly 100. The lock assembly 100 is configured to be selectively coupled to the selectively-movable lock member 902 of the mortise-cylinder housing 900 of the mortise cylinder 901.

FIG. 2 and FIG. 3 are each applicable to the first embodiment and the second embodiment. In accordance with the first and second embodiments as depicted in FIG. 2 and FIG. 3, a building 916 has a stationary wall 914. A stationary door frame 904 is configured to be mounted to the stationary wall 914 of the building 916. A movable door 912 is configured to be mounted to (preferably, pivotally mounted to) the stationary door frame 904. The movable door 912 is also configured to be selectively movable between a door-closed condition (as depicted in FIG. 2) and a door-open condition (as depicted in FIG. 3).

In accordance with the first and second embodiments as depicted in FIG. 1, FIG. 2, FIG. 3 and FIG. 41, a latch housing 908 is configured to be mounted in an edge section 910 of the movable door 912. This is done in such a way that the latch housing 908, in use, faces the stationary door frame 904 once the latch housing 908 is mounted (as depicted in FIG. 2) in the edge of the movable door 912, and once the movable door 912 is moved (as depicted in FIG. 2) from the open-door condition to the closed-door condition. The latch housing 908, in use, supports (has, includes, or is configured to support) a latch device 906 (also called a movable latch device). An embodiment of the latch housing 908 is manufactured by the ADAMS RITE Company, which is located in Arizona, U.S.A. It will be appreciated that the latch housing 908 may include (and is not limited to) a latch mechanism and/or any equivalent thereof, such as a bolt-action mechanism, etc. It will be appreciated that the term “latch” may include any mechanism or device configured to take (receive) a mortise cylinder (such as, a mortise cassette, ADAMS RITE (TRADEMARK) device (ADAMS RITE is a trademark of the Adams Rite Company based in Arizona, USA), a detex unit, the exterior side of a push bar, etc., and any other kind or any equivalent thereof), and that the concept is suitable for any mechanisms utilized in the industry.

In accordance with FIG. 2 (which is applicable to both the first and second embodiments), the latch device 906 is configured to selectively latch (selectively bolt or selectively couple) with the stationary door frame 904 once the latch housing 908, in use, is mounted in the edge section 910 of the movable door 912, and once the latch housing 908, in use, faces the stationary door frame 904. This is done in such a way that (A) the latch device 906, in use, securely prevents movement of the movable door 912 away from the stationary door frame 904, and (B) the movable door 912, in use, remains in the door-closed condition with the latch device 906 placed in a latched condition.

In accordance with FIG. 3 (which is applicable to both the first and second embodiments), the latch device 906 is configured to selectively unlatch (selectively unbolt or selectively decouple) from the stationary door frame 904. This is done in such a way that (A) the latch device 906, in use, permits free movement of the movable door 912 away from the stationary door frame 904, and (B) the movable door 912 is movable to the door-open condition with the latch device 906 placed in an unlatched condition.

A technical advantage applicable to both the first and second embodiments is that there may be fewer service calls required for the case where the lock assembly 100 may be reset (if desired) without requiring a service call from a locksmith. In addition, access control may be less of a concern for the case where a key cannot be handed to undesirables to be used at any time.

In accordance with the embodiments as depicted in FIG. 1, FIG. 2, FIG. 3 and FIG. 41, a mortise-cylinder housing 900 (of a mortise cylinder 901) is configured to be selectively receivable by, and supportable by, and selectively removable from, the latch housing 908. Preferably, this is done (occurs) once the latch housing 908 is mounted in the edge of the movable door 912.

In accordance with the first and second embodiments as depicted in FIG. 1, FIG. 2, FIG. 3 and FIG. 41, the mortise-cylinder housing 900 supports (includes, has or is configured to support) a selectively-movable lock member 902 (also called a door-lock cam, and any other kind, and any equivalent thereof). The selectively-movable lock member 902 is configured to interface with the latch device 906 of the latch housing 908 once the mortise-cylinder housing 900, in use, is received by, and supported by, the latch housing 908.

A lock assembly 100 is configured to be selectively coupled to (to be interfaced with) the selectively-movable lock member 902 of the mortise-cylinder housing 900 of the mortise cylinder 901.

For instance, in accordance with the first embodiment (as depicted in FIG. 1), the lock assembly 100 is configured to be received and contained in the mortise-cylinder housing 900 of the mortise cylinder 901. The lock assembly 100 is configured to be directly selectively coupled to the selectively-movable lock member 902 of the mortise-cylinder housing 900 of the mortise cylinder 901. This is done in such a way that the lock assembly 100 is received within (and preferably remains within) an interior of the mortise-cylinder housing 900 of the mortise cylinder 901. It will be appreciated that in accordance with the first embodiment, the lock assembly 100 and the mortise cylinder 901 are integrated into a single unit (and the single unit is to be installed to, or in, the latch housing 908, in which the latch housing 908 is installed to and supported by the movable door 912). For instance, for the case where an existing mortise cylinder is to be removed (in which the existing mortise cylinder is standard existing equipment) from the latch housing 908, and then is to be replaced with a new mortise cylinder, the combination of the lock assembly 100 and the mortise cylinder 901 is installed (in place of the existing mortise cylinder), as a single unit, to the latch housing 908. For the first embodiment, the lock assembly 100 and the mortise cylinder 901 are not selectively user removable from each other.

For instance, in accordance with the second embodiment (as depicted in FIG. 41), the lock assembly 100 is configured to not be received and contained in the mortise-cylinder housing 900 of the mortise cylinder 901, and the lock assembly 100 is configured to be retrofitted to an existing (conventional) mortise-cylinder housing of a mortise cylinder. The lock assembly 100 is configured to be indirectly selectively coupled to the selectively-movable lock member 902 of the mortise-cylinder housing 900 of the mortise cylinder 901. This is done in such a way that the lock assembly 100 is positioned exteriorly of the mortise-cylinder housing 900 of the mortise cylinder 901. The lock assembly 100 is coupled (either directly or indirectly) to, for instance, an exterior portion of the mortise-cylinder housing 900 of the mortise cylinder 901. It will be appreciated that in accordance with the second embodiment, the lock assembly 100 and the mortise cylinder 901 are selectively removable (user removable) from each other (preferably while the mortise cylinder 901, in use, remains supported by the latch housing 908). Preferably, the lock assembly 100 and the mortise cylinder 901 are selectively removable from each other while the mortise cylinder 901, in use, remains supported by (and received by) the latch housing 908 (in which the latch housing 908 is installed to and supported by the movable door 912). For instance, for the case where it is not required to remove an existing mortise cylinder (in which the existing mortise cylinder is standard existing equipment) from the latch housing 908, the lock assembly 100 is installed to the existing mortise cylinder that is (or remains) installed to the latch housing 908.

In accordance with the first and second embodiments as depicted in FIG. 1, FIG. 2, FIG. 3 and FIG. 41, the lock assembly 100 includes visible symbols 102. The visible symbols 102 are configured to be selectively movable. This is done in such a way that the visible symbols 102, in use, urge the selectively-movable lock member 902 of the mortise-cylinder housing 900 of the mortise cylinder 901 to move from a locked state to an unlocked state.

In accordance with the first embodiment (as depicted in FIG. 1), the lock assembly 100 is configured to be received in, and mounted within, an interior of the mortise-cylinder housing 900 of the mortise cylinder 901. The visible symbols 102 are positioned exteriorly of the mortise-cylinder housing 900 of the mortise cylinder 901 once the lock assembly 100 is received in, and mounted within, the interior of the mortise-cylinder housing 900 of the mortise cylinder 901.

In accordance with the second embodiment as depicted in FIG. 41, the lock assembly 100 is configured to interface with a key 350. The key 350 is configured to be received, at least in part, into a keyway 903 of the mortise cylinder 901 (as depicted in the embodiment of FIG. 44). The lock assembly 100 is configured to be selectively coupled to the selectively-movable lock member 902 of the mortise-cylinder housing 900 of the mortise cylinder 901 via the key 350. The lock assembly 100 is configured to be positioned exteriorly of the mortise-cylinder housing 900 of the mortise cylinder 901 once the key 350, in use, is received, at least in part, into the keyway 903 of the mortise cylinder 901. The visible symbols 102 are positioned exteriorly of the mortise-cylinder housing 900 of the mortise cylinder 901. The lock assembly 100 and the mortise cylinder 901 are selectively removable from each other while the mortise cylinder 901, in use, remains supported by the latch housing 908.

In accordance with the embodiments as depicted in FIG. 37 (which depicts the first embodiment) and FIG. 62 (which depicts the second embodiment), the visible symbols 102 are configured to be positionable in the locked state in which the visible symbols 102, in use, do not move the selectively-movable lock member 902, and the selectively-movable lock member 902, in use, does not move the latch device 906 from the latched condition (as depicted in FIG. 2) to the unlatched condition (as depicted in FIG. 3).

In accordance with the embodiments as depicted in FIG. 35 (which depicts the first embodiment), and FIG. 64 (which depicts the second embodiment), the visible symbols 102 are configured to be positionable in the unlocked state in which the visible symbols 102, in use, move the selectively-movable lock member 902, and (in response) the selectively-movable lock member 902, in use, moves the latch device 906 from the latched condition (as depicted in FIG. 2) to the unlatched condition (as depicted in FIG. 3).

In accordance with the embodiment as depicted in FIG. 2 (applicable to both the first and second embodiments), in the latched condition, the latch device 906 is latched to the stationary door frame 904 so that the movable door 912 is immovably secured in the locked state with the stationary door frame 904.

In accordance with the embodiment as depicted in FIG. 3 (applicable to both the first and second embodiments), in the unlatched condition, the latch device 906 is unlatched from the stationary door frame 904 so that the movable door 912 is unlocked and free to be movable (moved) away from or toward the stationary door frame 904.

FIG. 1 depicts a perspective view of the first embodiment of a lock assembly 100.

FIG. 2 and FIG. 3 depict front views of embodiments of the lock assembly 100 of FIG. 1 and FIG. 41 (FIG. 2 and FIG. 3 are both applicable to the first and second embodiments).

FIG. 4 and FIG. 5 depict a front view (FIG. 4) and a side view (FIG. 5) of embodiments of the lock assembly 100 of FIG. 1.

FIG. 6 depicts a perspective view of an embodiment of the lock assembly 100 of FIG. 1.

In accordance with the embodiments as depicted in FIG. 1 to FIG. 6, the lock assembly 100 includes a combination lock device. The lock assembly 100 is configured to selectively open and/or selectively close a pin-tumbler lock mechanism. The lock assembly 100 is configured to move the selectively-movable lock member 902 (also called a cam, etc.), and the selectively-movable lock member 902 (in response to being moved) then, in use, moves, or urges the movement of, the latch device 906. Generally, the lock assembly 100 includes components configured to be movable, such as the visible symbols 102 (also called indicia, symbols, numbers, and any other kind, and any equivalent thereof).

In accordance with an embodiment, the lock assembly 100 is configured to be operable with a by-pass key (known and not depicted) in addition to utilization of the selective movement of the visible symbols 102. In accordance with another embodiment, the lock assembly 100 is not configured to be operable with a by-pass key (known and not depicted) in addition to utilization of the movement of the visible symbols 102.

Preferably, the lock assembly 100 includes a dial 206 (a movable dial, a combination dial, a dial face, etc.), and the visible symbols 102 (indicia) are placed on the outer surface of the dial 206. The lock assembly 100 is configured to open only for the case where the dial 206 is turned through a predetermined sequence of predetermined positions (known in advance), in which the predetermined positions are identified on the dial face of the dial 206 by the visible symbols 102 (numbers, letters, and any other kind, and any equivalent thereof). For instance, the lock assembly 100 is configured to be opened for the case where a specific sequence of symbols (of the visible symbols 102) are displayed on the dial 206 (displayed relative to the reference marker 207). The lock assembly 100 is configured to be opened by rotating the dial 206 through a set of predetermined positions in a prescribed order and direction (a special sequence), and any other kind, and any equivalent thereof.

The lock assembly 100 is configured to operate by the movement of a sequence of symbols for opening the lock assembly 100 (a lock device). The sequence may be entered using a single rotating dial (such as, the dial 206) configured to interact with components (discs and/or cams, etc.).

In accordance with the first embodiment, the lock assembly 100 has the dial 206 (in which the mortise cylinder 901 does not present a keyway configured to receive a key for opening the lock contained in the mortise cylinder 901), in which the dial 206 is configured to be rotated to latch open or close the selectively-movable lock member 902 that is positioned on the latch housing 908.

Preferably, the mortise-cylinder housing 900 of the mortise cylinder 901 is configured to be threaded and screwed into the latch housing 908 (in which the latch housing 908 has the latch device 906) that is mounted within the movable door 912. The mortise cylinder 901 is configured to be held (supported) in place by the latch housing 908. The latch housing 908 includes the selectively-movable lock member 902 (also called a cam) to actuate the latch device 906 positioned in the latch housing 908.

In accordance with an embodiment, it will be appreciated that a controller (known and not depicted) and wires (known and not depicted) may be utilized for remote locking and/or unlocking of the latch device 906 positioned in the latch housing 908 (if so desired).

In accordance with the embodiments as depicted in FIG. 1 to FIG. 6, the lock assembly 100 includes a turn handle 202, a dial 206, threads 210, and a front plate 212. The lock assembly 100 includes the dial 206. The dial 206 includes a faceplate with numbers formed on the outer surface with graduations or liens extending radially toward the outer periphery of the dial 206. The dial 206 is rotatably mounted to the mortise-cylinder housing 900 of the mortise cylinder 901.

The front plate 212 is affixed to the front end section of the mortise-cylinder housing 900 of the mortise cylinder 901. The front plate 212, in use, faces away from the door once the mortise cylinder 901 is mounted to the door.

The mortise-cylinder housing 900 includes the threads 210 (configured to threadably connect with the latch housing 908, as depicted in FIG. 1). The front plate 212 is positioned behind the dial 206.

The turn handle 202 is rotatably mounted to the mortise-cylinder housing 900. The turn handle 202 extends through the central zone of the dial 206. The turn handle 202 extends from the mortise-cylinder housing 900. The dial 206 is positioned behind the turn handle 202. The turn handle 202 is configured to be selectively rotated by a user in such a way that the turn handle 202, in use, urges the rotation of the dial 206 (clockwise and/or counter clockwise).

FIG. 7 depicts a cross-sectional side view (which is taken along a cross-sectional line A-A of FIG. 6) of the embodiments of the lock assembly 100 of FIG. 6.

In accordance with the embodiment as depicted in FIG. 7, the lock assembly 100 further includes a turn shaft 204 (in which the turn shaft 204 defines a shaft groove 209), a dial shaft 208 (combination dial shaft), a turn-shaft gear 214, a rotation axis 216 (extending through the mortise-cylinder housing 900), a gear shaft 218, a gear 220, a slide spring 222, a slide device 224 (in which the slide device 224 defines a slide channel 225), a first tumbler disk 226, a second tumbler disk 228, a third tumbler disk 230, a tumbler retainer 232, a back plate 234, and a slide body 238 (in which the slide body 238 defines a slide channel 236).

The turn shaft 204 is configured to be selectively rotatable. The turn shaft 204 has a rotation axis 216 extending therethrough. The turn shaft 204 is configured to be rotatable about the rotation axis 216. The rotation axis 216 extends through the turn shaft 204. A distal end portion of the turn shaft 204 is configured to be affixed to the turn handle 202. This is done in such a way that once the turn handle 202 is made to be rotatable by the user, the turn shaft 204 is accordingly selectively rotated. An end portion of the turn shaft 204 is affixed to the turn-shaft gear 214. This is done in such a way that rotation of the turn shaft 204, in use, urges rotation of the turn-shaft gear 214.

The dial shaft 208 is configured to be selectively rotatable. The rotation axis 216 extends through the dial shaft 208. The dial shaft 208 is affixed to the dial 206. This is done in such a way that once the dial 206 is made to be selectively rotated by the user, the dial shaft 208 is accordingly selectively rotated (this is done in such a way that the selective rotation of the dial 206, in use, urges the selective rotation of the dial shaft 208).

The turn shaft 204 and the dial shaft 208 are configured to rotate (clockwise and/or counter clockwise) along the rotation axis 216. The turn shaft 204 and the dial shaft 208 are coaxially aligned (one within the other). Preferably, the dial shaft 208 provides (defines) an elongated hole extending along the rotation axis 216, and the dial shaft 208 is configured to receive the turn shaft 204. Preferably, the turn shaft 204 and the dial shaft 208 are coaxially aligned (with the turn shaft 204 received or positioned within the dial shaft 208). The turn shaft 204 and the dial shaft 208 are configured to be rotatably supported by the mortise cylinder 901. The turn shaft 204 and the dial shaft 208 are configured to be rotatable (independently rotatable of each other) once the turn shaft 204 and the dial shaft 208 are rotatably supported by the mortise cylinder 901.

The gear 220 is rotatably mounted to the mortise cylinder 901. The gear shaft 218 is rotatably coupled to the gear 220. The turn-shaft gear 214 is rotatably coupled to the gear 220. This is done in such a way that rotation of the turn-shaft gear 214, in use, urges rotation of the gear 220 and the gear shaft 218 (rotation of the gear 220, in use, urges the rotation of the gear shaft 218). The gear shaft 218 is configured to be rotatably coupled to the selectively-movable lock member 902. This is done in such a way that rotation of the gear shaft 218, in use, urges rotation of the selectively-movable lock member 902. Selective rotation of the dial shaft 208, in use, urges the rotation of the selectively-movable lock member 902.

The selectively-movable lock member 902 is rotatably supported by (rotatably mounted to) the mortise cylinder 901. Preferably, the selectively-movable lock member 902 is rotatably mounted to an exterior (to the rear section) of the mortise cylinder 901.

Selective rotation of the turn shaft 204, in use, urges rotation of the selectively-movable lock member 902 between (A) the closed condition (as depicted in the embodiment of FIG. 2 for the case where the lock assembly 100 is locked), and (B) the open condition (as depicted in the embodiment of FIG. 3 for the case where the lock assembly 100 is unlocked).

For the case where the lock assembly 100 is locked (is placed in a locked condition), the lock assembly 100, in use, prevents the selective rotation of the turn shaft 204, and therefore prevents the selective rotation of the selectively-movable lock member 902 between the open condition (as depicted in the embodiment of FIG. 3) and the closed condition (as depicted in the embodiment of FIG. 2).

The first tumbler disk 226 is affixed to the dial shaft 208 (this is done is such a way that rotation of the dial shaft 208, in use, urges the selective rotation of the first tumbler disk 226).

The second tumbler disk 228 and the third tumbler disk 230 are rotatably mounted to the dial shaft 208 (this is done in such a way that the second tumbler disk 228 and the third tumbler disk 230 are freely rotatable on the dial shaft 208).

The tumbler retainer 232 is affixed to an exterior portion of the dial shaft 208. The tumbler retainer 232 is configured to retain the position of the second tumbler disk 228 and the third tumbler disk 230 between the tumbler retainer 232 and the first tumbler disk 226 (once the tumbler retainer 232 is affixed to an exterior portion of the dial shaft 208).

Selective rotation of the dial shaft 208, in use, urges selective rotation of the first tumbler disk 226. The first tumbler disk 226 is configured to selectively interface with (selectively contact) the second tumbler disk 228. The first tumbler disk 226 is configured to selectively move the second tumbler disk 228 once the first tumbler disk 226, in use, selectively contacts the second tumbler disk 228, and once the first tumbler disk 226 is selectively rotated by the dial shaft 208.

The second tumbler disk 228 is configured to selectively interface with (selectively contact) the third tumbler disk 230. The second tumbler disk 228 is configured to selectively move the third tumbler disk 230 once the second tumbler disk 228, in use, selectively contacts the third tumbler disk 230, and once the second tumbler disk 228 is selectively rotated by the first tumbler disk 226.

The slide device 224 is configured to selectively latch with the first tumbler disk 226, the second tumbler disk 228 and the third tumbler disk 230 between (A) a locked condition (a latched condition, as depicted in the embodiment of FIG. 37), and (B) an unlocked condition (an unlatched condition, as depicted in the embodiment of FIG. 35). Preferably, the slide device 224 provides (defines) the slide channel 225 that is configured to selectively latch with an aspect of the first tumbler disk 226, the second tumbler disk 228 and the third tumbler disk 230 (as is described in further details below).

In the unlocked condition (as depicted in the embodiment of FIG. 35), the slide device 224, in use, prevents rotation of the first tumbler disk 226, the second tumbler disk 228 and the third tumbler disk 230.

In the locked condition (as depicted in the embodiment of FIG. 37), the slide device 224, in use, permits the rotation of the first tumbler disk 226, the second tumbler disk 228 and the third tumbler disk 230.

The slide spring 222 is configured to bias the movement of the slide device 224 from the locked condition (depicted in the embodiment of FIG. 37) toward the unlocked condition (depicted in the embodiment of FIG. 35).

The turn shaft 204 is configured to selectively move the slide device 224 from the unlocked condition (depicted in the embodiment of FIG. 35) toward the locked condition (depicted in the embodiment of FIG. 37).

FIG. 8 and FIG. 9 depict a cross-sectional side view (FIG. 8, which is taken along a cross-sectional line A-A of FIG. 6) and a cross-sectional front view (FIG. 9, which is taken along a cross-sectional line B-B of FIG. 8) of embodiments of the lock assembly 100 of FIG. 6.

Referring to the embodiment as depicted in FIG. 8, the slide body 238 is positioned along a lower section of the mortise-cylinder housing 900 approximately midway between the front portion and the rear portion of the mortise-cylinder housing 900. The slide body 238 is configured to support the location (position) of the slide device 224 (which is depicted in FIG. 7). Once the slide device 224 is placed in the locked condition (as depicted in FIG. 37), the turn shaft 204 is not rotatable (and the turn shaft 204 cannot be utilized in order to move the selectively-movable lock member 902, and the selectively-movable lock member 902 remains in a locked condition or position). Once the slide device 224 is placed in the unlocked condition (as depicted in FIG. 35), the turn shaft 204 is rotatable (and the turn shaft 204 is utilized or moved in order to move the selectively-movable lock member 902).

In accordance with the embodiment as depicted in FIG. 9, the slide device 224 provides (defines) the slide channel 236. The slide device 224 is configured to be selectively received in (and preferably in contact with) the slide channel 236 of the slide device 224 (as depicted in FIG. 7).

In accordance with the embodiment as depicted in FIG. 8 and FIG. 9, the front plate 212 defines a first hole 402 configured to receive the dial shaft 208 (as depicted in FIG. 7).

FIG. 10 and FIG. 11 depict a cross-sectional bottom view (FIG. 10, which is taken along a cross-sectional line C-C of FIG. 8) and a perspective view (FIG. 11) of embodiments of the lock assembly 100 of FIG. 6.

In accordance with the embodiment as depicted in FIG. 10, the slide channel 236 is positioned (located) in a midsection of the slide body 238. Preferably, the slide body 238 spans between the lower opposite sides of the mortise-cylinder housing 900. The slide body 238 is positioned approximately midway between the front plate 212 and the rear section of the mortise-cylinder housing 900.

In accordance with the embodiment as depicted in FIG. 11, the slide body 238 forms a crescent-shaped body having a curved lower section that conforms to the inner curved shape of the mortise-cylinder housing 900.

FIG. 12, FIG. 13 and FIG. 14 depict a side view (FIG. 12), a front view (FIG. 13) and a side view (FIG. 14) of embodiments of the lock assembly 100 of FIG. 7.

In accordance with the embodiments as depicted in FIG. 12 and FIG. 13, the back plate 234 is substantially flat. The back plate 234 defines (provides) the second hole 404 and the third hole 406. The second hole 404 is positioned in the central zone of the back plate 234. The third hole 406 is positioned between the second hole 404 and the outer edge of the back plate 234. The third hole 406 is configured to receive the gear shaft 218 (as depicted in FIG. 7). The second hole 404 is configured to receive the dial shaft 208, with the turn shaft 204 positioned in the center of the dial shaft 208 (as depicted in FIG. 7).

In accordance with the embodiments as depicted in FIG. 14, the turn handle 202 is affixed to a distal end portion of the turn shaft 204. The turn-shaft gear 214 is positioned on the opposite end of the turn shaft 204 (opposite from the placement of the turn handle 202 to the turn shaft 204).

The turn shaft 204 provides (defines) a shaft groove 209 configured to selectively interact with (selectively contact) the slide device 224 (as depicted in FIG. 7). The shaft groove 209 is configured to selectively interact with the slide device 224 (as described in connection with the description of FIG. 31 and FIG. 32).

FIG. 15 and FIG. 16 depict a side view (FIG. 15) and a front view (FIG. 16) of embodiments of the lock assembly 100 of FIG. 6.

In accordance with the embodiment as depicted in FIG. 15, the turn-shaft gear 214 has been removed from the opposite end of the turn shaft 204 to better show the shaft groove 209 formed on the outer surface of the turn shaft 204.

In accordance with the embodiment as depicted in FIG. 16, the turn handle 202 forms an elongated body that is relatively flatter shaped than the diameter of the turn shaft 204 and the diameter of the turn-shaft gear 214.

FIG. 17 and FIG. 18 depict a side view (FIG. 17) and a front view (FIG. 18) of embodiments of the lock assembly 100 of FIG. 7.

In accordance with the embodiment as depicted in FIG. 17, the first tumbler disk 226 is affixed to an outer portion of the dial shaft 208 (between the opposite end sections of the dial shaft 208). The first extension member 408 extends from the first tumbler disk 226, and also extends away from the dial 206 once the dial 206 is mounted to the end portion of the dial shaft 208. The fourth hole 410 (provided by or defined by the dial shaft 208) extends between the opposite end sections of the dial shaft 208. The fourth hole 410 is configured to receive the turn shaft 204 (as depicted in FIG. 7). The dial 206 defines (provides) the fifth hole 412 that extends into the dial 206. The fifth hole 412 is configured to receive, at least in part, the end portion of the dial shaft 208.

In accordance with the embodiment as depicted in FIG. 18, the first extension member 408 extends (along an axial direction) from one side of the first tumbler disk 226. The first extension member 408 is configured to selectively contact the second contact member associated with the second tumbler disk 228 (as depicted in FIG. 19).

The first tumbler disk 226 defines (provides) the first central hole 418, and the first central hole 418 is configured to receive the dial shaft 208 (as depicted in FIG. 17). The first tumbler disk 226 defines (provides) the first lock hole 414, and the first lock hole 414 is configured to selectively interact with (selectively latch and unlatch with) the slide device 224 (as depicted in FIG. 29 and FIG. 30). A radial line extends through the first lock hole 414 along a radial direction from the center of the first tumbler disk 226. Another radial line extends through the first extension member 408 along another radial direction from the center of the first tumbler disk 226. A first angle 416 extends between the radial lines that extend through the first extension member 408 and the first lock hole 414.

FIG. 19, FIG. 20A, FIG. 21B and FIG. 21 depict front views of embodiments of the lock assembly 100 of FIG. 7.

In accordance with the embodiment as depicted in FIG. 19, the second tumbler disk 228 provides (defines) the second lock hole 420, and the second lock hole 420 is configured to selectively interact with the slide device 224 (in a similar manner as the first lock hole 414 of the first tumbler disk 226). The second tumbler disk 228 also defines (provides) the second central hole 422, and the second central hole 422 is configured to receive the dial shaft 208 (as depicted in FIG. 7 and FIG. 22). The second extension member 424 extends from each of the opposite sides of the second tumbler disk 228 (as depicted in FIG. 22).

A radial line extends through the second lock hole 420 along a radial direction from the center of the second tumbler disk 228. Another radial line extends through the second extension member 424 along another radial direction from the center of the second tumbler disk 228. A second angle 426 extends between the radial lines that extend through the second lock hole 420 and the second extension member 424.

In accordance with the embodiment as depicted in FIG. 20A, the third tumbler disk 230 provides (defines) the third lock hole 428. The third tumbler disk 230 also defines (provides) the third central hole 430 for receiving the dial shaft 208 (as depicted in FIG. 7 and FIG. 22). The third tumbler disk 230 includes the third extension member 432 that extends from one side of the third tumbler disk 230. The third extension member 432 is configured to selectively contact the second extension member 424 of the second tumbler disk 228.

In accordance with the embodiment as depicted in FIG. 20B, the first extension member 408 of the first tumbler disk 226 is configured to selectively contact (and move) the second extension member 424 of the second tumbler disk 228 (once the first tumbler disk 226 is selective rotated by the dial shaft 208). The second extension member 424 of the second tumbler disk 228 is configured to selectively contact (and move) the third extension member 432 of the third tumbler disk 230, which then rotates the 230 (once the second tumbler disk 228 is selectively rotated accordingly). Therefore, once the first extension member 408, in use, is made to contact (and move) the second extension member 424 (once the 226 is made to rotate by the rotation of the dial shaft 208), the dial shaft 208 can then be further rotated in such a way that the second extension member 424, in use, contacts (and moves) the third extension member 432 (which then urges rotation of the third tumbler disk 230).

A radial line extends through the third lock hole 428 along a radial direction from the center of the third tumbler disk 230. Another radial line extends through the third extension member 432 along another radial direction from the center of the third tumbler disk 230. A third angle 434 extends between the radial lines that extend through the third lock hole 428 and the third extension member 432.

In accordance with the embodiment as depicted in FIG. 21, the tumbler retainer 232 provides (defines) the retainer hole 436 configured to receive the dial shaft 208. The tumbler retainer 232 is configured to be affixed to an outer section (surface) of the dial shaft 208 (as depicted in FIG. 7).

FIG. 22 depicts a side view of an embodiment of the lock assembly 100 of FIG. 6.

In accordance with the embodiment as depicted in FIG. 22, the turn-shaft gear 214 defines the gear hole 438, in which the gear hole 438 is configured to receive (at least in part) the turn shaft 204. The turn-shaft gear 214 is configured to be affixed to an end portion of the dial shaft 208.

The tumbler retainer 232 provides (defines) the retainer hole 436, in which the retainer hole 436 is configured to receive the dial shaft 208. The tumbler retainer 232 is configured to be affixed to the dial shaft 208 in such a way that the tumbler retainer 232, in use, retains the position (location) of the third tumbler disk 230 and the second tumbler disk 228 on the dial shaft 208, and the third tumbler disk 230 and the second tumbler disk 228 are located between the second tumbler disk 228 and the tumbler retainer 232.

The third tumbler disk 230 defines the third central hole 430, in which the third central hole 430 is configured to receive the dial shaft 208. The third tumbler disk 230 includes the third extension member 432 extending from one side of the third tumbler disk 230. The third extension member 432 (of the third tumbler disk 230), in use, faces the second extension member 424 (of the second tumbler disk 228). The third extension member 432 is configured to selectively contact the second extension member 424 (once the second extension member 424 is made to be rotated).

The second tumbler disk 228 defines the second central hole 422, in which the second central hole 422 is configured to receive the dial shaft 208. The second extension member 424 extends from the opposite lateral sides of the second tumbler disk 228. The second extension member 424, in use, faces the first extension member 408 (of the first tumbler disk 226). The second extension member 424 is configured to selectively contact the first extension member 408 (in response to the rotation of the first extension member 408 by the dial shaft 208).

The second extension member 424, in use, also faces the third extension member 432 (of the third tumbler disk 230). The second extension member 424 is also configured to selectively contact the third extension member 432 (in response to the rotation of the first extension member 408 by the dial shaft 208, and in response to the rotation of the second tumbler disk 228 by the rotation of the first tumbler disk 226).

The dial shaft 208 is received by the fifth hole 412 of the dial 206. The turn shaft 204 is received in the fourth hole 410 of the dial shaft 208. As well, the turn shaft 204 is received in the fifth hole 412 of the dial 206.

FIG. 23, FIG. 24, FIG. 25 and FIG. 26 depict a side view (FIG. 23), a top view (FIG. 24), an end view (FIG. 25) and a cross-sectional view (FIG. 26, which is taken along a cross-sectional line D-D of FIG. 23) of embodiments of the lock assembly 100 of FIG. 7.

In accordance with the embodiment as depicted in FIG. 23, FIG. 24, FIG. 25 and FIG. 26, the slide device 224 includes a crown 227. The slide device 224 defines (provides) the first channel 225A. The slide device 224 also defines (provides) the second channel 225B. The first channel 225A and the second channel 225B are positioned on opposite sides of the crown 227.

The slide device 224 defines the slide hole 442, in which the slide hole 442 is configured to receive (at least in part) the turn shaft 204 (as depicted in FIG. 7). The slide hole 442 is configured to interact with (cam with) the turn shaft 204 (as depicted in FIG. 31 and FIG. 32).

FIG. 27 to FIG. 30 depict side views of embodiments of the lock assembly 100 of FIG. 7.

In accordance with the embodiment as depicted in FIG. 27, the first lock hole 414 (of the first tumbler disk 226), the second lock hole 420 (of the second tumbler disk 228) and the third lock hole 428 (of the third tumbler disk 230) are not rotatably aligned to face a common radial direction (in sharp contrast with the embodiments of FIG. 29 and FIG. 30 in which the first lock hole 414, the second lock hole 420 and the third lock hole 428 are aligned to face a common radial direction). For this case (as depicted in FIG. 27), the slide device 224, in use, contacts any one of the outer peripheral edges of the first tumbler disk 226, the second tumbler disk 228 and the third tumbler disk 230 so that the slide device 224, in use, is prevented from being moved (that is, the slide device 224 remains stationary as depicted in FIG. 37, in which the selectively-movable lock member 902 is prevented from being rotated or moved).

The dial shaft 208 is configured to be rotated, so that the first extension member 408 of the second tumbler disk 228 is then rotated (since the second tumbler disk 228 is affixed to the dial shaft 208). Continued rotation of the first extension member 408 eventually results in selective contact of the first extension member 408 with the second extension member 424 (of the second tumbler disk 228), and the second extension member 424 with the third extension member 432 (of the third tumbler disk 230). The dial shaft 208 is selectively rotated, accordingly until the first lock hole 414, the second lock hole 420 and the third lock hole 428 are co-aligned to face a common radial direction as depicted in FIG. 29 and FIG. 30.

It will be appreciated that while the first lock hole 414 (of the first tumbler disk 226), the second lock hole 420 (of the second tumbler disk 228) and the third lock hole 428 (of the third tumbler disk 230) are not rotatably aligned to face a common radial direction, the selectively-movable lock member 902 is not permitted to be rotated (as depicted in FIG. 37).

In accordance with the embodiment as depicted in FIG. 28, the first lock hole 414 faces the crown 227 of the slide device 224, while the second lock hole 420 and the third lock hole 428 are positioned to not face the crown 227 of the slide device 224. It will be appreciated that further continued rotation of the dial shaft 208 is required to selectively rotate the second lock hole 420 and the third lock hole 428 into co-alignment and to face a common radial direction as depicted in FIG. 29 and FIG. 30.

It will be appreciated that for FIG. 28, the slide device 224, in use, is prevented from being moved (the slide device 224 remains stationary as depicted in FIG. 37, in which the selectively-movable lock member 902 is prevented from being rotated or moved).

In accordance with the embodiment as depicted in FIG. 29, the first lock hole 414, the second lock hole 420 and the third lock hole 428 are rotated and aligned (in unison) to face a common radial direction toward the crown 227 of the slide device 224. For this case, the slide spring 222, in use, moves (urges) the slide device 224 into (at least in part) each of the first lock hole 414, the second lock hole 420 and the third lock hole 428, and the selectively-movable lock member 902 is permitted to be rotated (as depicted in FIG. 35).

The turn shaft 204 becomes rotatable once the slide device 224, in use, is moved into (at least in part) each of the first lock hole 414, the second lock hole 420 and the third lock hole 428.

The dial shaft 208 is prevented from being rotatable once the slide device 224, in use, is moved into (at least in part) each of the first lock hole 414, the second lock hole 420 and the third lock hole 428.

In accordance with the embodiment as depicted in FIG. 30, the slide device 224, in use, is moved in such a way that the selectively-movable lock member 902 is permitted to be rotated or moved, as depicted in FIG. 35.

FIG. 31 to FIG. 34 depict side views of embodiments of the lock assembly 100 of FIG. 7.

In accordance with the embodiment as depicted in FIG. 31, the slide device 224 defines the slide hole 442, in which the slide hole 442 is configured to receive (at least in part) the turn shaft 204. The slide hole 442 is configured to interact with (cam with) the turn shaft 204.

The shaft groove 209 (of the turn shaft 204) is configured to selectively interact with the slide device 224. Preferably, the shaft groove 209 (of the turn shaft 204) is configured to selectively cam with the slide device 224.

Once the first lock hole 414, the second lock hole 420 and the third lock hole 428 are rotated and aligned (in unison) to face a common radial direction toward the crown 227 of the slide device 224 (as depicted in FIG. 30), the shaft groove 209, in use, faces a lower surface of the slide hole 442 of the slide device 224. The slide spring 222 urges the slide device 224 upwardly toward the top section of the mortise-cylinder housing 900.

The turn shaft 204 is configured to be rotatable in such a way that the cam surface associated with the shaft groove 209 contacts the lower cam surface associated with the slide hole 442.

In accordance with the embodiment as depicted in FIG. 32, continued rotation of the turn shaft 204 results in a camming action between the turn shaft 204 (the cam surface associated with the shaft groove 209) and the camming surface associated with the slide hole 442 (of the slide device 224). Continued rotation of the turn shaft 204 urges the slide device 224 to move downwardly (as depicted in FIG. 33).

In accordance with the embodiment as depicted in FIG. 33, rotation of the turn shaft 204 resulted in the movement of the slide device 224 out from the first lock hole 414, the second lock hole 420 and the third lock hole 428 (which face a common radial direction toward the crown 227 of the slide device 224). For this case, the dial shaft 208 is free to be rotated.

In accordance with the embodiment as depicted in FIG. 34, continued rotation of the dial shaft 208 results in the misalignment of the first lock hole 414, the second lock hole 420 and the third lock hole 428. The slide device 224, in use, contacts the outer peripheral edges of the dial shaft 208, the second tumbler disk 228 and the third tumbler disk 230.

FIG. 35 depicts a cross-sectional view (taken along a cross-sectional line A-A of FIG. 6) of an embodiment of the lock assembly 100 of FIG. 6 (in which the lock assembly 100 is positioned in an unlocked condition).

In accordance with the embodiment as depicted in FIG. 35, once the slide device 224 is placed in (moved to) the unlocked condition (as depicted in FIG. 35), the slide device 224 is engaged (latched) with the first tumbler disk 226, the second tumbler disk 228 and the third tumbler disk 230 (in such a way that the first tumbler disk 226, the second tumbler disk 228 and the third tumbler disk 230 are not rotatable in the unlocked condition). The unlocked condition refers to the free movement of the selectively-movable lock member 902.

The slide device 224 is configured to selectively latch with the first tumbler disk 226, the second tumbler disk 228 and the third tumbler disk 230 between (A) a locked condition (a latched condition, as depicted in the embodiment of FIG. 37), and (B) an unlocked condition (an unlatched condition, as depicted in the embodiment of FIG. 35).

In the unlocked condition (as depicted in the embodiment of FIG. 35), the slide device 224, in use, prevents rotation of the first tumbler disk 226, the second tumbler disk 228 and the third tumbler disk 230. In the locked condition (as depicted in the embodiment of FIG. 37), the slide device 224, in use, permits the rotation of the first tumbler disk 226, the second tumbler disk 228 and the third tumbler disk 230.

The slide spring 222 is configured to bias the movement of the slide device 224 from the locked condition (depicted in the embodiment of FIG. 37) toward the unlocked condition (depicted in the embodiment of FIG. 35).

The turn shaft 204 is configured to selectively move the slide device 224 from the unlocked condition (depicted in the embodiment of FIG. 35) toward the locked condition (depicted in the embodiment of FIG. 37).

FIG. 36 depicts an end view of an embodiment of the lock assembly 100 of FIG. 35.

In accordance with the embodiment as depicted in FIG. 36, the selectively-movable lock member 902 is placed in the unlatched condition (that is, the selectively-movable lock member 902 is free to be moved, which is also depicted in FIG. 3).

FIG. 37 depicts a cross-sectional view (taken along a cross-sectional line A-A of FIG. 6) of an embodiment of the lock assembly 100 of FIG. 6 (in which the lock assembly 100 is positioned in a locked condition).

In accordance with the embodiment as depicted in FIG. 37, once the slide device 224 is placed in (moved to) the locked condition (as depicted in FIG. 37), the slide device 224 is not engaged (not latched) with the first tumbler disk 226, the second tumbler disk 228 and the third tumbler disk 230 (in such a way that the first tumbler disk 226, the second tumbler disk 228 and the third tumbler disk 230 are free to be rotatable. The locked condition refers to the non-rotatable condition of the selectively-movable lock member 902.

The slide device 224 is configured to selectively latch with the first tumbler disk 226, the second tumbler disk 228 and the third tumbler disk 230 between (A) a locked condition (a latched condition, as depicted in the embodiment of FIG. 37), and (B) an unlocked condition (an unlatched condition, as depicted in the embodiment of FIG. 35).

In the unlocked condition (as depicted in the embodiment of FIG. 35), the slide device 224, in use, prevents rotation of the first tumbler disk 226, the second tumbler disk 228 and the third tumbler disk 230.

In the locked condition (as depicted in the embodiment of FIG. 37), the slide device 224, in use, permits the rotation of the first tumbler disk 226, the second tumbler disk 228 and the third tumbler disk 230.

The slide spring 222 is configured to bias the movement of the slide device 224 from the locked condition (depicted in the embodiment of FIG. 37) toward the unlocked condition (depicted in the embodiment of FIG. 35).

The turn shaft 204 is configured to selectively move the slide device 224 from the unlocked condition (depicted in the embodiment of FIG. 35) toward the locked condition (depicted in the embodiment of FIG. 37).

FIG. 38 depicts an end view of an embodiment of the lock assembly 100 of FIG. 37.

In accordance with the embodiment as depicted in FIG. 37, the selectively-movable lock member 902 is placed in the latched condition (that is, the selectively-movable lock member 902 is not free to be moved, which is also depicted in FIG. 2).

FIG. 39 and FIG. 40 depict an end view (FIG. 39) and a side view (FIG. 40) of embodiments of the lock assembly 100 of FIG. 7.

FIG. 2, FIG. 3 and FIG. 41 to FIG. 65 depict views in accordance with aspects of a second embodiment of a lock assembly 100 (FIG. 2 and FIG. 3 are both applicable to the first and second embodiments).

FIG. 41 depicts a perspective view of the second embodiment of a lock assembly 100.

FIG. 42 and FIG. 43 depict side views of embodiments of the lock assembly 100 of FIG. 41.

In accordance with the embodiments as depicted in FIG. 41, FIG. 42 and FIG. 43, the lock assembly 100 is configured to be selectively connectable to the mortise-cylinder housing 900 (and removable from), without the need to replace the mortise-cylinder housing 900 (and/or the internal mechanisms of the mortise-cylinder housing 900). The mortise-cylinder housing 900 is configured to be operated with a key 350 (as depicted in the embodiments of FIG. 42 and FIG. 43). The key 350 is inserted into the mortise-cylinder housing 900. The lock assembly 100 is configured to be coupled to the key 350. The lock assembly 100 is further configured to selectively (securely) move the key 350 in such a way that the lock assembly 100, in use, selectively locks and unlocks the mortise-cylinder housing 900 (via selective movement of the key 350 by the operation of the lock assembly 100).

In accordance with the embodiments as depicted in FIG. 42, the mortise-cylinder housing 900 includes a flange assembly 918 (a collar) configured to surround the front plate 212 of the mortise-cylinder housing 900. The flange assembly 918 is positioned between the front plate 212 and the movable door 912.

In accordance with the embodiments as depicted in FIG. 43, the flange assembly 918 is removed from between the front plate 212 and the movable door 912, thereby revealing a gap 922. The gap 922 is configured (dimensioned) to receive (at least in part) a portion of the lock assembly 100 (in order to permit the lock assembly 100 to be securely coupled to the housing of the mortise-cylinder housing 900).

FIG. 44 and FIG. 45 depict a perspective view (FIG. 44) and a side view (FIG. 45) of embodiments of the lock assembly 100 of FIG. 41.

In accordance with the embodiment as depicted in FIG. 44 and FIG. 45, the mortise-cylinder housing 900 is configured to operatively receive the key 350. Rotation of the key 350, in use, urges movement (rotation) of the selectively-movable lock member 902 of the mortise-cylinder housing 900. The lock assembly 100 is configured to operatively selectively and securely rotate (move) the key 350 while the key 350 is received in the keyway 903 (keyhole) of the mortise-cylinder housing 900. This is done in such a way that operation of the lock assembly 100, in use, operatively selectively and securely rotates (moves) the key 350 while the key 350 is received in the keyway 903 (keyhole) of the mortise-cylinder housing 900.

In accordance with the embodiment as depicted in FIG. 45, the lock assembly 100 includes a main housing 302 and a holder 320. The main housing 302 and a holder 320 are configured to be selectively securely coupled together (as depicted in FIG. 47).

The main housing 302 and the holder 320 are configured to be received (at least in part) in the gap 922 (formed between the front plate 212 of the mortise-cylinder housing 900 and the stationary wall 914).

Once the main housing 302 and the holder 320 are received (at least in part) in the gap 922, the main housing 302 and the holder 320, in use, are selectively securely coupled together (as depicted in FIG. 48).

In accordance with the embodiment as depicted in FIG. 45, the lock assembly 100 further includes the main housing 302, the removable housing 304, a turn handle 306 (similar to the turn handle 202 of FIG. 4), a first numbered dial 308, a second numbered dial 310, a third numbered dial 312, and a fourth numbered dial 314, the holder 320, a first gear 322, a second gear 324, a third gear 326, a fourth gear 328, a dial shaft 330, a first tumbler disc 332, a second tumbler disc 334, a third tumbler disc 336, a fourth tumbler disc 338, a first tumbler disc gear 340, a second tumbler disc gear 342, a third tumbler disc gear 344, a fourth tumbler disc gear 346, a tumbler disc shaft 348, a turnkey adapter 352, and a turn shaft 354.

The dial shaft 330 is configured to be rotatably mounted to the main housing 302. The dial shaft 330 extends between the front section and the rear section of the main housing 302 (once the dial shaft 330 is rotatably mounted to the main housing 302).

The first numbered dial 308, the second numbered dial 310, the third numbered dial 312 and the fourth numbered dial 314 are rotatably mounted to the dial shaft 330. The first numbered dial 308, the second numbered dial 310, the third numbered dial 312 and the fourth numbered dial 314 are spaced apart from each other (once the first numbered dial 308, the second numbered dial 310, the third numbered dial 312 and the fourth numbered dial 314 are rotatably mounted to the dial shaft 330).

The first gear 322, the second gear 324, the third gear 326 and the fourth gear 328 are rotatably mounted to the dial shaft 330. The first gear 322, the second gear 324, the third gear 326 and the fourth gear 328 are spaced apart from each other (once the first gear 322, the second gear 324, the third gear 326 and the fourth gear 328 are rotatably mounted to the dial shaft 330).

The first numbered dial 308 and the first gear 322 are affixed to each other (so that the first numbered dial 308 and the first gear 322 are rotatable in unison with each other). The second numbered dial 310 and the second gear 324 are affixed to each other (so that the second numbered dial 310 and the second gear 324 are rotatable in unison with each other). The third numbered dial 312 and the third gear 326 are affixed to each other (so that the third numbered dial 312 and the third gear 326 are rotatable in unison with each other). The fourth numbered dial 314 and the fourth gear 328 are affixed to each other (so that the fourth numbered dial 314 and the fourth gear 328 are rotatable in unison with each other).

The tumbler disc shaft 348 is configured to be rotatably mounted to the main housing 302. The tumbler disc shaft 348 extends between the front section and the rear section of the main housing 302 (once the tumbler disc shaft 348 is rotatably mounted to the main housing 302). The tumbler disc shaft 348 is positioned below the dial shaft 330 in a spaced-apart relationship.

The first tumbler disc 332, the second tumbler disc 334, the third tumbler disc 336 and the fourth tumbler disc 338 are rotatably mounted to the tumbler disc shaft 348. The first tumbler disc 332, the second tumbler disc 334, the third tumbler disc 336 and the fourth tumbler disc 338 are spaced apart from each other (once the first tumbler disc 332, the second tumbler disc 334, the third tumbler disc 336 and the fourth tumbler disc 338 are rotatably mounted to the tumbler disc shaft 348).

The first tumbler disc gear 340, the second tumbler disc gear 342, the third tumbler disc gear 344 and the fourth tumbler disc gear 346 are rotatably mounted to the tumbler disc shaft 348. The first tumbler disc gear 340, the second tumbler disc gear 342, the third tumbler disc gear 344 and the fourth tumbler disc gear 346 are spaced apart from each other (once the first tumbler disc gear 340, the second tumbler disc gear 342, the third tumbler disc gear 344 and the fourth tumbler disc gear 346 are rotatably mounted to the tumbler disc shaft 348).

The first tumbler disc gear 340 and the first tumbler disc 332 are affixed to each other (so that the first tumbler disc gear 340 and the first tumbler disc 332 are rotatable in unison with each other). The second tumbler disc gear 342 and the second tumbler disc 334 are affixed to each other (so that the second tumbler disc gear 342 and the second tumbler disc 334 are rotatable in unison with each other). The third tumbler disc gear 344 and the third tumbler disc 336 are affixed to each other (so that the third tumbler disc gear 344 and the third tumbler disc 336 are rotatable in unison with each other). The fourth tumbler disc gear 346 and the fourth tumbler disc 338 are affixed to each other (so that the third tumbler disc gear 344 and the fourth tumbler disc 338 are rotatable in unison with each other).

The first gear 322 and the first tumbler disc gear 340 are configured to interface (mate) with each other (such that rotation of the first gear 322, in use, urges rotation of the first tumbler disc gear 340). The second gear 324 and the second tumbler disc gear 342 are configured to interface (mate) with each other (such that rotation of the second gear 324, in use, urges rotation of the second tumbler disc gear 342). The third gear 326 and the third tumbler disc gear 344 are configured to interface (mate) with each other (such that rotation of the third gear 326, in use, urges rotation of the third tumbler disc gear 344). The fourth gear 328 and the fourth tumbler disc gear 346 are configured to interface (mate) with each other (such that rotation of the fourth gear 328, in use, urges rotation of the fourth tumbler disc gear 346).

The turn shaft 354 is configured to be rotatably mounted to the main housing 302. The turn shaft 354 extends between the front section and the rear section of the main housing 302 (once the turn shaft 354 is rotatably mounted to the main housing 302). The turn shaft 354 provides features (such as grooves) configured to selectively interact (interface) with the first tumbler disc 332, the second tumbler disc 334, the third tumbler disc 336 and the fourth tumbler disc 338 between a locked condition (as depicted in FIG. 62, in which the selectively-movable lock member 902 is not movable or not rotatable) and an unlocked condition (as depicted in FIG. 64, in which the selectively-movable lock member 902 is movable or rotatable).

The turnkey adapter 352 is configured to be affixed to an end portion of the turn shaft 354, and the turnkey adapter 352 is configured to be selectively coupled to the key 350 (once the lock assembly 100 is mounted to the mortise-cylinder housing 900).

In the locked condition (as depicted in FIG. 62), the turn shaft 354, in use, cannot be utilized to rotate the turnkey adapter 352 (so that the key 350 cannot be utilized to rotate the selectively-movable lock member 902). It will be appreciated that for the case where the first numbered dial 308, the second numbered dial 310, the third numbered dial 312 and the fourth numbered dial 314 are not positioned or moved into a predetermined position and/or sequence, the turn shaft 354 may not be utilized to selectively move the selectively-movable lock member 902.

In the unlocked condition (as depicted in FIG. 64), the turn shaft 354, in use, can be utilized to rotate the turnkey adapter 352 (so that the key 350 can be utilized to rotate the selectively-movable lock member 902). It will be appreciated that for the case where the first numbered dial 308, the second numbered dial 310, the third numbered dial 312 and the fourth numbered dial 314 are positioned or moved into a predetermined position and/or sequence, the turn shaft 354 may be utilized to selectively move the selectively-movable lock member 902.

The lock assembly 100 is configured to selectively release the movement of the selectively-movable lock member 902 of the mortise-cylinder housing 900 for the case where a set of dials (such as, the first numbered dial 308, the second numbered dial 310, the third numbered dial 312 and the fourth numbered dial 314) selectively show a specific sequence of symbols (a predetermined sequence of symbols). The lock assembly 100 is configured to be opened by rotating one or more dials through a set of positions in a prescribed order and/or direction (a special sequence). The lock assembly 100 is a type of locking device in which a sequence of numbers or symbols is used to open the lock assembly 100. The sequence may be entered using a single rotating dial that is configured to interact with a disc or a cam by using a set of rotating discs with inscribed numerals, which interact with the locking mechanism, or through an electronic or mechanical keypad. The lock assembly 100 is configured to be opened for the case where a set of dials (wheels) releases (or turns) the tumblers of a lock to show a specific sequence of numbers.

FIG. 46 and FIG. 47 depict front views of embodiments of the lock assembly 100 of FIG. 45.

In accordance with the embodiment as depicted in FIG. 46, the holder 320 includes a curved (shaped) portion configured to conform (at least in part) with the outline (diameter) of the mortise-cylinder housing 900. The holder 320 is placed above the gap 922 (depicted in FIG. 45), and the holder 320 is moved (downwardly) toward the mortise-cylinder housing 900 and into the gap 922.

The main housing 302 includes a curved (shaped) portion configured to conform (at least in part) with the outline (diameter) of the mortise-cylinder housing 900. The main housing 302 is placed below the gap 922 (depicted in FIG. 45), and the main housing 302 is moved (upwardly) toward the mortise-cylinder housing 900 and into the gap 922.

In accordance with the embodiment as depicted in FIG. 47, the main housing 302 and the holder 320 are configured to be selectively (securely) snap fitted with each other once the holder 320 is moved (downwardly) toward the mortise-cylinder housing 900 and into the gap 922, and once the main housing 302 is moved (upwardly) toward the mortise-cylinder housing 900 and into the gap 922.

FIG. 48 depicts a side view of an embodiment the lock assembly 100 of FIG. 41.

FIG. 49 depicts a side view of an embodiment the lock assembly 100 of FIG. 41.

In accordance with the embodiment as depicted in FIG. 48, the lock assembly 100 further includes a removable housing 304 configured to be securely connectable (mated) to the main housing 302. It will be appreciated that the holder 320 and the removable housing 304 may be an integrated unit (if so desired).

In accordance with the embodiment as depicted in FIG. 49, the lock assembly 100 is selectively installed to the mortise-cylinder housing 900, with the removable housing 304 installed to the main housing 302 (so that the interior components of the lock assembly 100 are protected from unwanted tampering).

FIG. 50 and FIG. 51 depict a front view (FIG. 50) and a rear view (FIG. 51) of embodiments of the lock assembly 100 of FIG. 41.

In accordance with the embodiment as depicted in FIG. 50, the turn handle 306 extends from a frontal section of the main housing 302.

In accordance with the embodiment as depicted in FIG. 51, the mortise-cylinder housing 900 is depicted as being mounted to the rear section of the lock assembly 100, with the selectively-movable lock member 902 extending from the rear of the mortise-cylinder housing 900.

FIG. 52, FIG. 53 and FIG. 54 depict a front view (FIG. 52), a rear view (FIG. 53) and a perspective view (FIG. 54) of embodiments of the lock assembly 100 of FIG. 41.

In accordance with the embodiment as depicted in FIG. 52, FIG. 53 and FIG. 54, the first gear 322 is positioned above the first tumbler disc gear 340. The first tumbler disc 332 defines (provides) a first notch 333 formed on a peripheral edge of the first tumbler disc 332.

FIG. 55 and FIG. 56 depict perspective views of embodiments of the lock assembly 100 of FIG. 41.

In accordance with the embodiment as depicted in FIG. 55, the first tumbler disc 332, the second tumbler disc 334, the third tumbler disc 336 and the fourth tumbler disc 338 each respectively defines a first notch 333, a second notch 335, a third notch 337 and a fourth notch 339.

In accordance with the embodiment as depicted in FIG. 56, the turnkey adapter 352 defines a key notch 353 configured to receive (at least in part) the key 350 (as depicted in FIG. 62). The turn shaft 354 defines (provides) a mating notch 355 configured to respectively interact with the notches provided by the first tumbler disc 332, the second tumbler disc 334, the third tumbler disc 336 and the fourth tumbler disc 338 (as depicted in FIG. 55).

FIG. 57 to FIG. 60 depict end views of embodiments of the lock assembly 100 of FIG. 41.

In accordance with the embodiment as depicted in FIG. 57, the first notch 333, the second notch 335, the third notch 337 and the fourth tumbler disc 338 are positioned at different angular relationships relative to each other. For this case, the turn shaft 354 cannot be moved (rotated) until each of the first notch 333, the second notch 335, the third notch 337 and the fourth tumbler disc 338 are moved to become respectively aligned with and to face the mating notch 355 of the turn shaft 354.

In accordance with the embodiment as depicted in FIG. 58, the first notch 333 has been moved to become aligned with the mating notch 355 of the turn shaft 354. However, the second notch 335, the third notch 337 and the fourth tumbler disc 338 are not yet positioned to respectively face (and align with) the turn shaft 354. The turn shaft 354 cannot be moved (rotated) until each of the first notch 333, the second notch 335, the third notch 337 and the fourth tumbler disc 338 are moved to become respectively aligned with (and to face) the mating notch 355 of the turn shaft 354. It will be appreciated that since the turn shaft 354 cannot be rotated, the turn shaft 354 cannot rotate the key 350; and, therefore, the turn the key 350 cannot be utilized to operate the mortise-cylinder housing 900 for the rotation of the selectively-movable lock member 902 (as depicted in FIG. 62).

In accordance with the embodiment as depicted in FIG. 59, the first notch 333, the second notch 335, the third notch 337 and the fourth tumbler disc 338 are moved and positioned to respectively face (and become aligned with) the mating notch 355 of the turn shaft 354. It will be appreciated that, for this case, the turn shaft 354 can be movable (rotatable), so that the mortise-cylinder housing 900 may be operated to rotate the selectively-movable lock member 902 (as depicted in FIG. 64).

In accordance with the embodiment as depicted in FIG. 60, since the first notch 333, the second notch 335, the third notch 337 and the fourth tumbler disc 338 have been moved and positioned to respectively face (and become aligned with) the mating notch 355 of the turn shaft 354, the turn shaft 354 has been moved (rotated). For this case, it will be appreciated that since the turn shaft 354 may be rotated, the turn shaft 354 can rotate the key 350; and, therefore, the key 350 can be utilized to operate the mortise-cylinder housing 900 for the rotation of the selectively-movable lock member 902 (as depicted in FIG. 64).

FIG. 61 depicts a perspective view of an embodiment of the lock assembly 100 of FIG. 41.

In accordance with the embodiment as depicted in FIG. 61, the first numbered dial 308, the second numbered dial 310, the third numbered dial 312, and the fourth numbered dial 314 are located on (and extend from) a top section of the removable housing 304.

FIG. 62 depicts a cross-sectional view (taken along a cross-sectional line E-E of FIG. 61) of an embodiment of the lock assembly 100 of FIG. 61 (in which the lock assembly 100 is positioned in a locked condition).

FIG. 63 depicts a rear view of an embodiment of the lock assembly 100 of FIG. 62.

FIG. 64 depicts a cross-sectional view (taken along a cross-sectional line E-E of FIG. 61) of an embodiment of the lock assembly 100 of FIG. 61 (in which the lock assembly 100 is positioned in an unlocked condition).

FIG. 65 depicts a rear view of an embodiment of the lock assembly 100 of FIG. 64.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a lock assembly being configured to be selectively coupled to a selectively-movable lock member of a mortise-cylinder housing of a mortise cylinder; and
the lock assembly including visible symbols being configured to be selectively movable in such a way that the visible symbols, in use, urge the selectively-movable lock member of the mortise-cylinder housing of the mortise cylinder to move from a locked state to an unlocked state.

2. The apparatus of claim 1, wherein:
the visible symbols are configured to be positionable in the locked state in which the visible symbols, in use, do not move the selectively-movable lock member, and the selectively-movable lock member, in use, does not move a latch device from a latched condition to an unlatched condition.

3. The apparatus of claim 2, wherein:
the visible symbols are configured to be positionable in the unlocked state in which the visible symbols, in use, move the selectively-movable lock member, and, in response, the selectively-movable lock member, in use, moves the latch device from the latched condition to the unlatched condition.

4. The apparatus of claim 2, wherein:
in the latched condition, the latch device is latched to a stationary door frame so that a movable door is immovably secured in the locked state with the stationary door frame.

5. The apparatus of claim 4, wherein:
in the unlatched condition, the latch device is unlatched from the stationary door frame so that the movable door is unlocked and free to be movable away from or toward the stationary door frame.

6. The apparatus of claim 1, wherein:
the lock assembly is configured to be received in, and mounted within, an interior of the mortise-cylinder housing of the mortise cylinder.

7. The apparatus of claim 1, wherein:
the visible symbols are positioned exteriorly of the mortise-cylinder housing of the mortise cylinder once the lock assembly is received in, and mounted within, the interior of the mortise-cylinder housing of the mortise cylinder.

8. The apparatus of claim 1, wherein:
the lock assembly is configured to interface with a key, in which the key is configured to be received, at least in part, into a keyway of the mortise cylinder.

9. The apparatus of claim 8, wherein:
the lock assembly is configured to be selectively coupled to the selectively-movable lock member of the mortise-cylinder housing of the mortise cylinder via the key.

10. The apparatus of claim 8, wherein:
the lock assembly is configured to be positioned exteriorly of the mortise-cylinder housing of the mortise cylinder once the key, in use, is received, at least in part, into the keyway of the mortise cylinder.

11. The apparatus of claim 1, wherein:
the visible symbols are positioned exteriorly of the mortise-cylinder housing of the mortise cylinder.

12. The apparatus of claim 1, wherein:
the lock assembly and the mortise cylinder are selectively removable from each other while the mortise cylinder, in use, remains supported by a latch housing.

13. An apparatus, comprising:
a lock assembly being configured to be selectively coupled to a selectively-movable lock member of a mortise-cylinder housing of a mortise cylinder, in which a building has a stationary wall, and in which a stationary door frame is configured to be mounted to the stationary wall of the building, and in which a movable door is configured to be mounted to the stationary door frame, and in which the movable door is also configured to be selectively movable between a door-closed condition and a door-open condition, and in which a latch housing is configured to be mounted in an edge section of the movable door in such a way that the latch housing, in use, faces the stationary door frame once the latch housing is mounted in the edge section of the movable door, and once the movable door is moved from an open-door condition to a closed-door condition, and in which the latch housing supports a latch device, and in which the latch device is configured to selectively latch with the stationary door frame once the latch housing, in use, is mounted in the edge section of the movable door, and once the latch housing, in use, faces the stationary door frame in such a way that the latch device, in use, securely prevents movement of the movable door away from the stationary door frame, and the movable door, in use, remains in the door-closed condition with the latch device placed in a latched condition, and in which the latch device is configured to selectively unlatch from the stationary door frame in such a way that the latch device, in use, permits free movement of the movable door away from the stationary door frame, and the movable door is movable to the door-open condition with the latch device placed in an unlatched condition, and in which the mortise-cylinder housing is configured to be selectively receivable by, and supportable by, and selectively removable from, the latch housing, and in which the mortise-cylinder housing supports the selectively-movable lock member, and the selectively-movable lock member is configured to interface with the latch device of the latch housing once the mortise-cylinder housing, in use, is received by, and supported by, the latch housing; and
the lock assembly including visible symbols being configured to be selectively movable in such a way that the visible symbols, in use, urge the selectively-movable lock member of the mortise-cylinder housing of the mortise cylinder to move from a locked state to an unlocked state.

14. An apparatus, comprising:
a building having a stationary wall; and
a stationary door frame being configured to be mounted to the stationary wall of the building; and
a movable door being configured to be mounted to the stationary door frame, and also configured to be selectively movable between a door-closed condition and a door-open condition; and
a latch housing being configured to be mounted in an edge section of the movable door in such a way that the latch housing, in use, faces the stationary door frame once the latch housing is mounted in the edge section of the movable door, and once the movable door is moved from an open-door condition to a closed-door condition; and
the latch housing being configured to support a latch device; and
the latch device being configured to selectively latch with the stationary door frame once the latch housing, in use, is mounted in the edge section of the movable door and once the latch housing, in use, faces the stationary door frame in such a way that the latch device, in use, securely prevents movement of the movable door away from the stationary door frame, and the movable door, in use, remains in the door-closed condition with the latch device placed in a latched condition; and
the latch device being configured to selectively unlatch from the stationary door frame in such a way that the latch device, in use, permits free movement of the movable door away from the stationary door frame, and the movable door is movable to the door-open condition with the latch device placed in an unlatched condition; and
a mortise-cylinder housing of a mortise cylinder, in which the mortise-cylinder housing is configured to be selectively receivable by, and supportable by, and selectively removable from, the latch housing; and
the mortise-cylinder housing supporting a selectively-movable lock member, and the selectively-movable lock member being configured to interface with the latch device of the latch housing once the mortise-cylinder housing, in use, is received by, and supported by, the latch housing; and
a lock assembly being configured to be selectively coupled to the selectively-movable lock member of the mortise-cylinder housing of the mortise cylinder; and
the lock assembly including visible symbols being configured to be selectively movable in such a way that the visible symbols, in use, urge the selectively-movable lock member of the mortise-cylinder housing of the mortise cylinder to move from a locked state to an unlocked state.

15. The apparatus of claim 14, wherein:
the lock assembly is configured to be received in, and mounted within, an interior of the mortise-cylinder housing of the mortise cylinder.

16. The apparatus of claim 14, wherein:
the visible symbols are positioned exteriorly of the mortise-cylinder housing of the mortise cylinder once the lock assembly is received in, and mounted within, the interior of the mortise-cylinder housing of the mortise cylinder.

17. The apparatus of claim 14, wherein:
the lock assembly is configured to interface with a key, in which the key is configured to be received, at least in part, into a keyway of the mortise cylinder; and
the lock assembly is configured to be selectively coupled to the selectively-movable lock member of the mortise-cylinder housing of the mortise cylinder via the key; and
the lock assembly is configured to be positioned exteriorly of the mortise-cylinder housing of the mortise cylinder once the key, in use, is received, at least in part, into the keyway of the mortise cylinder; and
the visible symbols are positioned exteriorly of the mortise-cylinder housing of the mortise cylinder.

18. The apparatus of claim 14, wherein:
the visible symbols are configured to be positionable in the locked state in which the visible symbols, in use, do not move the selectively-movable lock member, and the selectively-movable lock member, in use, does not move the latch device from the latched condition to the unlatched condition.

19. The apparatus of claim 14, wherein:
the visible symbols are configured to be positionable in the unlocked state in which the visible symbols, in use, move the selectively-movable lock member, and, in response, the selectively-movable lock member, in use, moves the latch device from the latched condition to the unlatched condition.

20. The apparatus of claim 14, wherein:
in the latched condition, the latch device is latched to the stationary door frame so that the movable door is immovably secured in the locked state with the stationary door frame; and
in the unlatched condition, the latch device is unlatched from the stationary door frame so that the movable door is unlocked and free to be movable away from or toward the stationary door frame.
